(19) United States
(12) Patent Application Publication
(10) Pub. No.: US 2024/0309944 A1
(43) Pub. Date: Sep. 19, 2024

(54) ADDITIVE PARALLEL LOAD PATH ACTUATOR USING FLUIDIC COUPLING

(71) Applicant: EXONETIK INC., Sherbrooke (CA)

(72) Inventors: Jean-Sébastien PLANTE, Sherbrooke (CA); Pascal LAROSE, Sherbrooke (CA); Jean-Philippe LUCKING BIGUE, Sherbrooke (CA)

(21) Appl. No.: 18/262,241

(22) PCT Filed: Feb. 1, 2022
(86) PCT No.: PCT/CA2022/050143

§ 371 Date: Jul. 20, 2023

Related U.S. Application Data
(60) Provisional application No. 63/143,974, filed on Feb. 1, 2021.

(51) Int. Cl. F16H 47/07

(52) U.S. Cl. CPC F16H 47/07

(57) ABSTRACT

An actuator system has a power source, an output member, a first fluidic coupling and a second fluidic coupling. The fluidic couplings generate a variable amount of torque transmission. A transmission operatively couples the fluidic couplings to the power source and to the output member in at least first load path and a second load path, the first load path and the second load path being parallel to one another, the first load path including the first fluidic coupling, the second load path including the second fluidic coupling. The fluidic couplings are operable for torque from the power source to be transmitted solely via the first load path, solely via the second load path, and cumulatively via the first load path and the second load path.

### CROSS-REFERENCE TO RELATED APPLICATIONS

The present application claims the priority of U.S. Patent Application No. 63/143,974, filed on Feb. 1, 2021 the contents of which are incorporated herein by reference.

### TECHNICAL FIELD

The present application relates generally to the field of actuators, robotic joints, haptic devices, hoists or powertrains, using magnetorheological (MR) fluid couplings.

### BACKGROUND OF THE ART

Actuators are devices that are used to generate a controllable force or torque on a system. A typical application of an actuator is found in a haptic system, robot or powertrain. Haptic systems are devices that may involve physical contact between an actuated device and a human user. Robots are devices that are operable to manipulate objects or perform tasks using a series of rigid links or members interconnected via articulations or actuated robotics joints. Typically, each joint provides one or more degrees of freedom (DOF) and is controlled by one or more actuators. End effectors are particular links used for performing certain tasks, e.g. grasping a work tool or an object.

Collaborative robots are robots that can be set up to work in environments close to humans and even to work together or assist humans in their work. Typical collaborative robots are robotic arms that include a plurality of interconnected robot joints enabling movements. In a variant, robot joints may include an output flange or shaft that can be connected to another robot joint and a joint motor configured to rotate the output flange or shaft. The robot joints can be connected directly together or a connecting element (e.g., link) can be provided between two robot joints. Typically collaborative robots have limited haptic capabilities due to the reflected inertia of the robotics joints that is caused by the high reduction ratio between the motor and the output flange or shaft.

Vehicle powertrains generally employ an internal combustion engine or a motor/generator unit that operate in concert with or without a gearbox to provide driving power to the wheels of a vehicle or equipment.

Human-hybrid type powertrains generally employ an internal combustion engine or a motor/generator unit that operate in concert with human power to provide driving power to the wheels of a vehicle or equipment. The internal combustion engine or electric drive capability of the vehicle is generally used where the human effort needs to be augmented or replaced because the human power is not enough to reach the desired performance or range. This type of vehicle or equipment is suited, by way of example, to maximise the range the human can go in the vehicle or equipment or to allow him/her to reach a distance otherwise unattainable without the sole contribution of human power or energy. Human-hybrid powertrains are not limited to using internal combustion engines or electric motors used in combination with human power but can also use an inertia wheel, air pressure turbine or other any other power source. It can also be composed of more than one additional power source combined with the human power. In general, for the purpose of simplifying the text, any power source other than human will be named additional power source.

Human-hybrid powertrains are not limited to using internal combustion engines or electric motors used in combination with human power but can also use an inertia wheel, air pressure turbine or other any other power source. It can also be composed of more than one additional power source combined with the human power. In general, for the purpose of simplifying the text, any power source, including the human will be named power source.

Vehicles employing a multi-speed powertrain are well suited for urban transportation where a significant amount of stop and go driving is undertaken. Some of these vehicles can also include regenerative braking to recharge the electrical power storage devices (batteries), to store energy in a flywheel or to pressurise a fluid in a reservoir, only to name a few examples. During urban travel, the powertrain may takes advantage of the power source and a multispeed gearbox to improve, as an example, performance and range.

A good example of a human hybrid multi-speed powertrain is known to be the moped. A moped is a small motorcycle, generally having less stringent licensing requirements than motorcycles, or automobiles, because mopeds typically travel about the same speed as bicycles on public roadways. Strictly speaking, mopeds are driven by both an internal combustion engine and by bicycle pedals. On a moped, there is usually a single ratio between the pedal and the wheel. On most mopeds, the pedals may become difficult to use once the vehicle has reached a certain speed because it is difficult to match the speed of the wheel with that of the pedals, the pedalling cadence being too high. In order to compensate for this occurrence, mopeds with multiple speed ratios between the pedals and the wheel have been introduced. In spite of this, because of the non-linear power and torque curve typical of internal combustion engines, it may be a challenge to have a moped engine that works seamlessly with human power. One approach would have the power coming from the engine proportionally to the power provided by the human but one problem in implementing this approach is that the torque coming from the internal combustion engine may be low at low speed. In order to patch this behaviour, a centrifugal slipping clutch may occasionally be added in order to couple the internal engine/transmission to the human power. The centrifugal clutch may not be easily controllable as the engagement is dependent on the speed of rotation of the motor. As additional device, a one-way clutch may be used in order to allow the internal combustion engine to overtake the speed of human power actuation while not dragging the mechanism that is in contact with the human. This one-way clutch is usually engaging or disengaging without a smooth transition. Internal combustion engines may also be difficult to control in torque and may have relatively slow answer, low bandwidth, compared to other power sources like electrical motors, for example.

Other types of moped are driven by electrical motors. Electrical motors may be easier to control because they may have higher bandwidths than internal combustion engine. On an electrical moped where high dynamic response is sought, the most common form of electromechanical actuation is found in direct-drive motors, which may be heavy for such modes of transportation. Device weight can be considerably reduced by providing a reduction ratio between the motor and the pedals or the wheel. Indeed, when coupled to reduction gearboxes, electromechanical actuators are much lighter and less expensive than direct drive solutions, but their high output inertia, friction and backlash greatly diminish their dynamic performance. They may not be controlled with the same bandwidth. Similar problems may arise as with the use of internal combustion engines where there are risks that the motor drags the movement of the human. As such, devices like one-way clutches may be required to connect the electrical motor and gearbox combination to the human power in order to ensure safety of the user.

In the examples of the internal combustion engine and electrical mopeds, in order to prevent the pedals from moving at a faster speed than desired, and associated risk of injuries or discomfort, a one-way clutch may be used as explained above. The one-way clutch may be operative every time the user stops turning the pedals while the engine outputs its mechanical power to the wheel, when the bandwidth of the motor speed reducer control does not decelerate the power source to match the user pedaling speed. Such hybrid systems may be not easily controlled due to their low bandwidth, the user may feel engagement and disengagement of the one-way clutch and the engagement and disengagement of the additional power source. Low bandwidth of the powertrain may be caused by the high inertia of rotating parts that are opposing speed changes in the system. When the user input speed varies, the high inertia of the system may become perceivable by the user and may cause annoyance. A system with a low bandwidth will not adapt fast enough to the change of the user such that the user may feel connected to a mechanical device. The annoyance may come from the fact that the mechanical system speed is not able to follow the user input speed, creating sticking points or unnatural movement. Hence, if it is desired to apply an assistance proportional to the user applied force to create the illusion of a smoother pedalling for the moped and the system has low bandwidth, the assistance may not adapt rapidly enough and may create a delay in the applied force that will be felt by the user. Usually, the bandwidth of standard powertrains may decrease as the speed of its rotating parts increases, hence their inertia also increase. For that reason, as the speed of rotating parts increases, the powertrain may lose its ability to adapt to the human change.

Other non-vehicle devices or equipment may also have multispeed powertrains since they need to be able to provide power at various speeds. A good example of this is a two-speed chain hoist. In such equipment, in a first operating mode the hoist reels a chain rapidly with low force capability, while the hoist reels a chain slowly with high force capability in a second operating mode. The operator of the hoist than operate the system in the most optimal mode according to the operating load or condition. In order to switch the system from one mode to the other, the operator usually needs to stop the movement, which is not desirable for efficiency of the operation since time is lost.

Fine dynamic motion control of mechanical/mechatronic systems fundamentally implies high performance actuators that exhibit rapid dynamics (bandwidth), high torque density (e.g., Nm/kg), low inertia and/or efficiency. Rapid or high dynamics are critical for the actuator to have authority over the system (load). If the dynamics are insufficient, the actuator will not respond fast enough and loose authority over the system (load). Typical high-dynamic actuators are direct-drive electric motors, that can reach speeds of several thousand RPM's and have force bandwidth well over 30 Hz. For torque density, in most mechanical or mechatronic systems, especially mobile systems that are in movement, such as electric vehicles, mobile robots or robotic arms, a high torque density is also required in order to minimise the system mass. Typical high torque density actuators are geared electric motors. The gearing allows a light weight system to generate high torque output, at the cost of reducing the output speed. The trade-off between torque (density) and dynamics imposed by the user of gearing between the actuator and load is a common and known engineering trade-off. Low inertia actuators are also important to maximise dynamic motion of a system. Lower inertia translates into higher acceleration for a given force/torque (F=ma), and thus higher reactivity and better dynamics. Low inertia actuators also promote efficiency, as they don't waste power fighting their own weight (inertia). Developing low inertia actuators is a major engineering challenge, for any system, as it is increased by the square of the gearing ratio (Iₒᵤₜ=Iᵢₙ×gearing²). Efficient actuators may also be important in order to minimise the weight of the system and the heat that it generates. If a system is not efficient, the system must be made larger (larger motor, power source, batteries, etc.) to compensate this loss of power. Moreover, the lost efficiency is converted to heat, which may require to oversize the component and add heat dissipations features (fins, cooling, etc.). Thus, gearing is often used to allow the actuator to work in its most efficient zone. For electric motors, this may be to work at higher speeds.

Consequently, actuator technologies may face a common fundamental trade-off, which is typically addressed or mitigated through appropriate gearing selection. This engineering challenge can be understood from an energetic perspective, such as shown in FIG. 1. When designing an actuator for a given application, the gearing trade-off between speed and torque limits the design space. When a single gearing (A) is used, the size, weight and performance of the system is fixed by the maximum torque (To) and maximum speed (Wo) requirements, as shown in i) by the iso-torque condition. A lower gearing will not match the torque requirement and a high gearing will not match the speed requirement. This provides a system with generally constant torque, or “iso-torque” output. Since the power is the product of torque and velocity, the power output from an “iso-torque” system linearly increases from zero at stall up to maximal power and the maximal speed, as observed ii). In this condition, the system mass, size and performance may not be optimal since the same actuator may be oversized for most operating conditions.

To overcome this challenge, a second gearing (B) may be added to the system in order to change the torque, speed and power output profiles, using a selector (shifter) such as shown in FIG. 2. The actuator may be better suited to meet the maximum speed or torque with different gearings (A or B). The system now has a torque, velocity, and power profile as shown in iii). This strategy is commonly found in transportation vehicles, which may combine any number of gearing stages to better match the maximum speed and torque profile required for various conditions of driving. As the number of gearing ratios tend towards infinity, such as in a constant variable transmission, the system tends towards an “iso-power” as in vi) of FIG. 1, between the larger gearing (A), that matches the maximum torque requirement, and the minimal gearing (B), that matches the maximum speed requirement. A constant power is thus provided between these two operating conditions. Amongst most important advantages, this configuration allows lower weight and better motor efficiency.

The problematics described above may be common to various applications where a combination of dynamics, torque density, low inertia and efficiency is required. Some applications may be bi-directional. One such application is for robotic joints for serial robots, that stack robotic joints in series using members or links. In such configuration, the actuators at the base of the robot must support the load of the following actuators. Torque density and efficiency are thus a critical feature, which make geared electric motors a common choice for robotic joints. However, since the robot must work rapidly and interact with the environment, its dynamics must be high and its inertia and must be low, making lightly geared actuator a prime candidate. Again, a trade-off exists between required to reach good global performance.

Other applications may be unidirectional, such as electric vehicles. As it is well known for gasoline powered vehicles, electric motors may also be made smaller, lighter, and more efficient if they are combined to one of more gearing. It is common knowledge that vehicles require high torque at low speeds, and low torque at high speeds. When no selector/shifter is used, the motor must be sized for both conditions. Motors are thus oversized for most operating conditions. However, shifters/selectors are not commonly used in electric vehicles, since they provide an interruption in torque during the shifting between gears. Automatic transmissions may be a solution, but may be bulky, complex and/or have limited performance vs gain.

While a multiple gear solution presents several advantages to optimize the size and power of the system, a simple transmission system with adequate performance must be selected. Moreover, fundamental limits still exist in a geared system. For instance, the actuator inertia will still be reflected to the system output according to the instantaneous gearing.

### SUMMARY

It is an aim of the present disclosure to provide a novel multi-speed parallel load path actuator that employs MR fluid coupling in order to connect a power source with an output.

It is further an aim of the present disclosure to present a multi-speed parallel load path actuator having multiple MR fluid actuators working together.

It is another aim of the present disclosure to present a parallel load path actuator that is having a MR fluid actuator contributing to transform a low bandwidth system into a high bandwidth system.

Therefore, in accordance with a first aspect, there is provided an actuator system comprising: a power source; an output member; at least a first fluidic coupling and a second fluidic coupling, the fluidic couplings operable to generate a variable amount of torque transmission; a transmission operatively coupling the at least two fluidic couplings to the power source and to the output member in at least first load path and a second load path, the first load path and the second load path being parallel to one another, the first load path including the first fluidic coupling, the second load path including the second fluidic coupling, wherein the fluidic couplings are operable for torque from the power source to be transmitted solely via the first load path, solely via the second load path, and cumulatively via the first load path and the second load path.

Further in accordance with the first aspect, for instance, at least one of the fluidic couplings is a magnetorheological (MR) fluid clutch apparatus, the MR fluid clutch apparatus operable to generate a variable amount of torque transmission when subjected to a magnetic field.

Still further in accordance with the first aspect, for instance, the first fluidic coupling and the second fluidic coupling are MR fluid clutch apparatuses.

Still further in accordance with the first aspect, for instance, the MR fluid clutch apparatus in only one of the MR fluid clutch apparatuses has a combination of a permanent magnet and an electromagnetic coil concurrently operable to vary the amount of torque transmission.

Still further in accordance with the first aspect, for instance, at least one of the fluidic couplings is a torque converter.

Still further in accordance with the first aspect, for instance, one of the fluidic couplings is replaced by a mechanical one-way freewheel device.

Still further in accordance with the first aspect, for instance, the transmission includes a first speed reduction mechanism in the first load path.

Still further in accordance with the first aspect, for instance, the transmission includes a second speed reduction mechanism in the second load path.

Still further in accordance with the first aspect, for instance, a reduction ratio of the first speed reduction mechanism differs from a reduction ratio of the second speed reduction mechanism.

Still further in accordance with the first aspect, for instance, the transmission includes intermeshed gears.

Still further in accordance with the first aspect, for instance, the transmission includes pulleys and belts.

Still further in accordance with the first aspect, for instance, a controller may be provided for controlling the fluidic couplings to selectively drive the output member solely in the first load path, solely in the second load path and cumulatively in the first load path and the second load path.

Still further in accordance with the first aspect, for instance, the first fluidic coupling has a first input coupled to the power source, and a first output to selectively transmit torque as a function of a control of the first fluidic coupling; the second fluidic coupling has a second input, and a second output to selectively transmit torque as a function of a control of the second fluidic coupling; the transmission has a first portion between the input of the first fluidic coupling and the input of the second fluidic coupling; the transmission has a second portion between the output of the first fluidic coupling and the output of the second fluidic coupling; the first load path includes the first input to the first output of the first fluidic coupling; the second load path includes the first input to the second input via the first portion of the transmission, the second input to the second output of the second fluidic coupling, and the second output to the first output via the second portion of the transmission.

Still further in accordance with the first aspect, for instance, a motor wheel may include a frame; an outer annular casing rotatingly mounted to the frame for rotation relative to the frame; the actuator system as described above, mounted to the frame, a gear arrangement between the actuator system and the outer annular casing to impart a rotation to the outer annular casing.

Still further in accordance with the first aspect, for instance, the gear arrangement includes a spiral bevel gear fixed to the output member, and a crown gear fixed to the outer annular casing.

In accordance with a second aspect, there is provided a system for driving an output member of an actuator system, the system comprising: a processing unit; a non-transitory computer-readable memory communicatively coupled to the processing unit and comprising computer-readable program instructions executable by the processing unit for: actuating a single power source; controlling a first fluidic coupling and a second fluidic coupling to transmit torque from the single power source to the output member in: a first load path including solely the first fluidic coupling, a second load path including solely the first fluidic coupling, and a combination of the first load path and the second load path.

In accordance with a third aspect, there is provided an actuator system comprising: at least two load paths, each of the load paths including at least a power source, and a fluidic coupling controllable to generate a variable amount of torque transmission; an output member common to the two at least two load paths; a transmission operatively coupling the at least two MR actuator units to the output member, for the output member to receive torque from the at least two load paths; wherein the fluidic couplings are controllable for torque from the power sources to be transmitted solely via the first load path, solely via the second load path, and cumulatively via the first load path and the second load path; and wherein at least one of the fluidic couplings is a torque converter.

Further in accordance with the third aspect, for instance, the transmission includes a first speed reduction mechanism in the first load path.

Still further in accordance with the third aspect, for instance, the transmission includes a second speed reduction mechanism in the second load path.

Still further in accordance with the third aspect, for instance, a reduction ratio of the first speed reduction mechanism differs from a reduction ratio of the second speed reduction mechanism.

Still further in accordance with the third aspect, for instance, the transmission includes intermeshed gears.

Still further in accordance with the third aspect, for instance, the transmission includes pulleys and belts.

Still further in accordance with the third aspect, for instance, a controller may be provided for controlling the fluidic couplings to selectively drive the output member solely in the first load path, solely in the second load path and cumulatively in the first load path and the second load path.

In accordance with a fourth aspect, there is provided a system for driving an output member of an actuator system, the system comprising: a processing unit; a non-transitory computer-readable memory communicatively coupled to the processing unit and comprising computer-readable program instructions executable by the processing unit for: actuating at least one power source; controlling a first fluidic coupling and a second fluidic coupling to transmit torque from the single power source to the output member in: a first load path including solely the first fluidic coupling, a second load path including solely the first fluidic coupling, and a combination of the first load path and the second load path.

Further in accordance with the fourth aspect, for instance, the first fluidic coupling is a torque converter, and wherein the computer-readable program instructions are executable by the processing unit for continuously increasing a torque from the first load path.

Still further in accordance with the fourth aspect, for instance, the computer-readable program instructions are executable by the processing unit for increasing a speed of the power source to continuously increase the torque from the first load path.

Still further in accordance with the fourth aspect, for instance, the computer-readable program instructions are executable by the processing unit for applying a braking force to an output of torque converter to continuously increase the torque from the first load path.

Still further in accordance with the fourth aspect, for instance, the computer-readable program instructions are executable by the processing unit for controlling a stator of the torque convertor to continuously increase the torque from the first load path.

Still further in accordance with the fourth aspect, for instance, the second fluidic coupling is a magnetorheological fluid coupling, and wherein the computer-readable program instructions are executable by the processing unit for controlling the magnetorheological fluid coupling to generate a variable amount of torque transmission via the second load path.

In an additional embodiment, the powertrain includes power sources; a multi-speed transmission connected to a final drive; and a selectively engageable magnetorheological fluid coupling (MRF) drivingly connected between the additional source and the multi-speed transmission. An MRF is operatively connected to the same output for selectively providing power to the powertrain or using the multi-speed transmission via the magnetorheological fluid clutches, and in some configurations, to receive energy from the magnetorheological fluid clutch for regenerative braking.

The multi-speed transmission may include a torque converter acting as a continuously variable transmission.

The power source may be connected to the input side or the output side of the magnetorheological fluid clutch.

These and other objects, features and advantages according to the present invention are provided by a multi-speed or multi-ratio parallel load path actuator which contains the MR fluid coupling or couplings.

Control means, such as a microprocessor operating under program control, is preferably operatively connected to the MR fluid force modulation means for causing a predetermined magnetic field strength to be applied to the MR fluid based upon a selected force modulation program that can take into account information from sensors. Accordingly, a desired amount of force or power from the power source can be provided to the powertrain in order to increase or decrease output of the powertrain during the vehicle usage. The system may further comprise a sensor to measure the input of the system in order to control the output required by the power source.

It is to be noted that the present invention can be used on all kind of haptic devices, robots, powertrains, brakes, suspensions, hoists, using various power sources inputs, like engine, electric motor, hydraulics, pneumatic as well as human input power sources like the arms, hands, feet, legs or any other body part. Also, the parallel load path actuator can be used on various types of vehicle or equipment like moped, push scooter, personal walker, electric car, hand powered cart, plane, bicycle trailer, hoist, only to name a few.

In equipment, the additive parallel load path actuator may be used to move objects combining power of a single power source connected to multiple speed transmission or multiple sources power. Benefit and principles stay the same than with vehicles. The objectives may still be to increase acceleration, improving control over the equipment or to provide more range or autonomy to the operated equipment.

### DESCRIPTION OF THE DRAWINGS

FIG. 1 is a series of graphs shown torque vs speed and power vs speed for 2-stage gearing in accordance with the prior art;

FIG. 2 is a block diagram of an actuation system with a selector/shifter between a power source and load in accordance with the prior art;

FIG. 3 is a schematic view of a generic magnetorheological (MR) fluid coupling, used by various embodiments of the present disclosure;

FIG. 4 is a perspective view of an MR fluid coupling of an embodiment of the present disclosure, as assembled;

FIG. 5 is a partly sectioned view of the MR fluid coupling of FIG. 4;

FIG. 6 is an exploded view of the MR fluid coupling of FIG. 4;

FIG. 7 is an enlarged view of the MR fluid coupling of FIG. 4, showing a magnetic field induced by a coil;

FIG. 8 is a partly sectioned view of the MR fluid coupling with a permanent magnet with a coil in an unpowered state, in accordance with another embodiment of the present disclosure;

FIG. 9 is a partly sectioned view of the MR fluid coupling of FIG. 8, with the coil in a powered state;

FIG. 10 is a section view of a fluidic coupling of torque converter type in accordance with the prior art;

FIG. 11 is a schematic representation of a single power source parallel load path actuator where the fluidic couplings are installed after speed reducers;

FIG. 11′ is a schematic representation of a single power-source parallel load path actuator where the fluidic couplings are installed before speed reducers;

FIG. 12 is a schematic representation of a multiple power source parallel load path actuator where the fluidic couplings are installed after speed reducers;

FIG. 12′ is a schematic representation of a multiple power source parallel load path actuator where the fluidic couplings are installed before speed reducers;

FIG. 13 is a schematic representation of an exemplary energetic situation of a parallel load path actuator;

FIG. 14 is a schematic graph of a signal that combines a low frequency force and a high frequency force.

FIG. 15 is a schematic view of a single power source parallel load path actuator where speed reducers are both before and after MR fluidic couplings;

FIG. 16 is a schematic view of a multiple power source parallel load path actuator where speed are reducers both before and after MR fluidic couplings;

FIG. 17 is a schematic representation of a fluidic coupling of torque converter type;

FIG. 18 is a schematic representation of a multiple power source parallel load path actuator where fluidic couplings of torque converter type are installed before speed reducers;

FIG. 19 is a schematic representation of a single power source parallel load path actuator where one fluidic coupling is of torque converter type and one another fluidic coupling is of MR type;

FIG. 20 is a schematic representation a parallel load path actuator that is composed of multiple parallel load path actuators;

FIG. 21 is a schematic representation of a wheel motor using a parallel load path actuator of the present disclosure;

FIG. 22 is the representation of torque transmission flowing through the two load paths in the wheel motor of FIG. 21;

FIG. 23 is a graphic representation an exemplary uninterrupted torque profile for the wheel motor using the parallel load path of FIG. 22;

FIG. 24 is a schematic view of a tethered lifting system using a parallel load path actuator of the present disclosure;

FIG. 25 is a perspective view of an actuator being a parallel combination of multiple sub-assemblies of power sources, hydrodynamic couplings and other fluidic couplings of the present disclosure;

FIGS. 26A and 26B are elevation views of a set of possible torque converter topologies for the present disclosure;

FIGS. 27A to 27D are a series of elevation views of torque converters joined in parallel load paths using a modular or integrated strategy;

FIGS. 28A to 28C are elevation views of a torque converter and MR fluid clutch apparatuses integrated into a single unit;

FIG. 29 is an elevation view of a disc brake caliper using a parallel load path actuator of the present disclosure;

FIG. 30 is a perspective view of a legacy parking brake actuator with high reduction ratio;

FIG. 31 is a schematic diagram of a parallel load path actuator using an inline wolfram type of gearbox; and

FIG. 32 is a schematic diagram of a parallel load path actuator using an alternative configuration wolfram type of gearbox.

### DETAILED DESCRIPTION

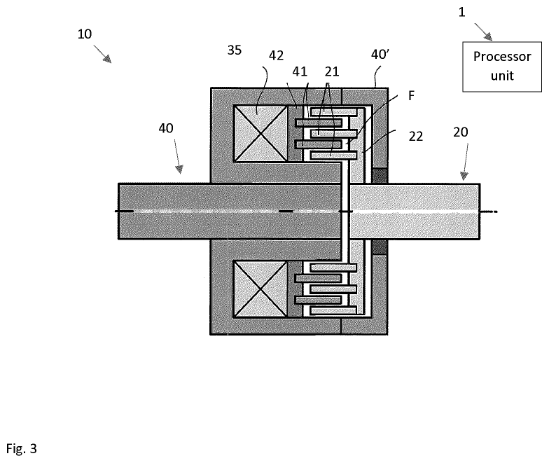

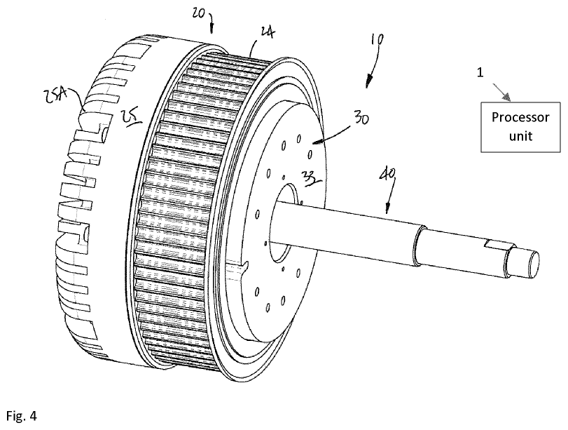

Referring to FIG. 3, there is illustrated a generic magnetorheological (MR) fluid coupling 10 (also known as a MR fluid clutch apparatus) configured to provide a mechanical output force based on a received input current provided by a processor unit 1 controlling the MR fluid coupling 10. The processor unit 1 is any type of electronic or electric device having controlling capability to control input current sent to the MR fluid coupling 10. In an embodiment, the processor unit 1 may receive signals from sensors, and compute data, for instance by way of firmware, to control the operation of the MR fluid coupling 10 based on settings, on requested assistance, etc., as will be explained hereinafter. The MR fluid coupling 10 has a driving member 20 with a disk 22 from which project drums 21 in an axial direction, this assembly also known as input rotor 20. The MR fluid coupling 10 also has a driven member 40 with a disk 42 from which project drums 41 intertwined with the drums 21 to define an annular chamber(s) filled with an MR fluid F. The drums 21 and 41 may be optional as it is possible to use disks only between the input rotor 20 and output rotor 40, in at least some of the embodiments described herein. The assembly of the driven member 40 and drums 41 is also known as the output rotor 40. The annular chamber is delimited by a casing 40′ that is integral to the driven member 40, and thus some surfaces of the casing 40 opposite the drums 21 are known as shear surfaces as they will collaborate with the drums 21 during torque transmission, as described below. The driving member 20 may be an input shaft in mechanical communication with a power input, and driven member 40 may be in mechanical communication with a power output (i.e., force output, torque output). MR fluid F is a type of smart fluid that is composed of magnetisable particles disposed in a carrier fluid, usually a type of oil. MR fluid may also be composed of magnetisable particles only, without fluid, and the MR fluid clutch apparatuses 10 described herein may use such magnetisable particles only. When subjected to a magnetic field, the fluid may increase its apparent viscosity, potentially to the point of becoming a viscoplastic solid. The apparent viscosity is defined by the ratio between the operating shear stress and the operating shear rate of the MR fluid F comprised between opposite shear surfaces—i.e., that of the drums 21 on the driving side, and that of the drums 41 and of the shear surfaces of the casing 40′ in the annular chamber. The magnetic field intensity mainly affects the yield shear stress of the MR fluid. The yield shear stress of the fluid when in its active (“on”) state may be controlled by varying the magnetic field intensity produced by electromagnet 35 integrated in the casing 40′, i.e., the input current, via the use of a controller such as the processor unit 1. Accordingly, the MR fluid's ability to transmit force can be controlled with the electromagnet 35, thereby acting as a clutch between the members 20 and 40. The electromagnet 35 is configured to vary the strength of the magnetic field such that the friction between the members 20 and 40 may be low enough to allow the driving member 20 to freely rotate with the driven member 40 and vice versa, i.e., in controlled slippage.

The driving member 20 is driven at a desired speed by a power source, like a rotary geared electric motor, and the output rotor is connected to a mechanical device to be controlled. The torque transmitted by the MR fluid coupling 10 is related to the intensity of the magnetic field passing through the MR fluid. The magnetic field intensity is modulated by a coil of the electromagnet 35, as controlled by the processor unit 1.

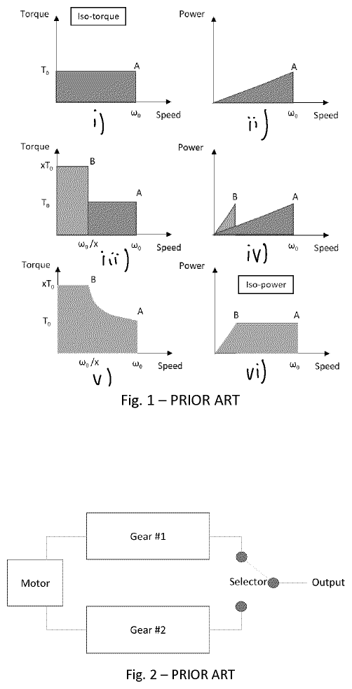

Referring to FIGS. 4, 5 and 6, the MR fluid coupling is generally shown at 10 as a whole. The MR fluid coupling 10 has similar components as the generic exemplary MR fluid coupling 10 of FIG. 1, whereby like reference numerals will refer to like components. The MR fluid coupling 10 has the input rotor 20, also known as the driving member, a stator 30 (including a coil), and the output rotor 40 also known as the driven member, and a MR fluid is located in an MR fluid chamber that is defined in the free space including the space between the drums of the rotor 20 and the rotor 40.

The input rotor 20 may be driven at a constant or variable speed prescribed by a rotary power source, not shown, like a rotary internal combustion engine or electric motor. The output rotor 40 is connected to a mechanical output, not shown, to be controlled. When a current circulates in the coil 35 of the stator 30, a magnetic field is induced in the stator 30 and passes through the drums and the MR fluid F. Then, a torque, dependent on the magnetic field intensity, is transmitted from the input rotor 20 to the output rotor 40 by shearing the MR fluid F in between the drums. Although the description that follows indicates that the rotor 20 is the input rotor and the rotor 40 is the output rotor, it is pointed out that the rotor 20 could be the output rotor and the rotor 40 could be the input rotor. However, for the sake of clarity and simplicity and to avoid unnecessary redundancy, the description will pursue with “input rotor 20” and “output rotor 40”.

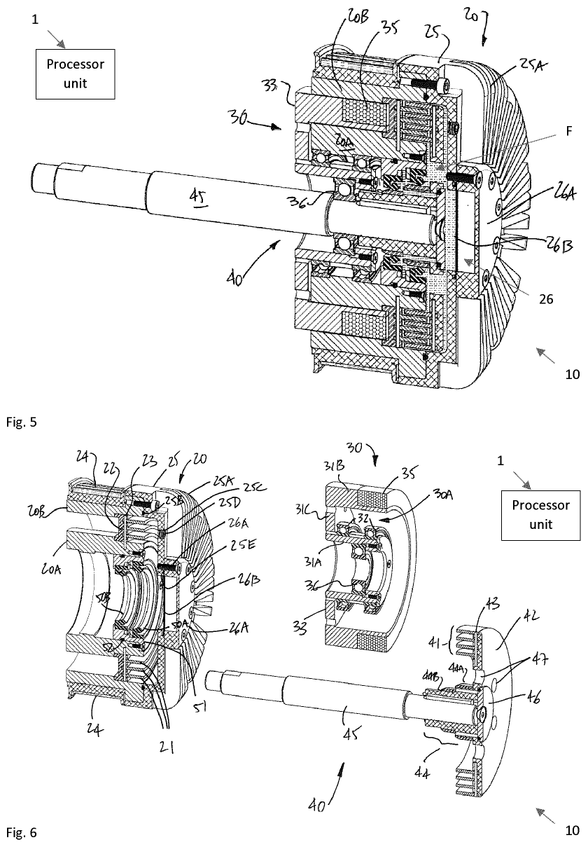

As best seen in FIGS. 5 and 6, the input rotor 20 has an inner magnetic core 20A and an outer magnetic core 20B, spaced apart from one another. The inner magnetic core 20A and outer magnetic core 20B are made of a ferromagnetic material that may have a high permeability, a high magnetization saturation, a high electrical resistivity and low hysteresis, such as silicon iron. Materials having a high electrical resistivity allow the magnetic field to establish faster by minimizing Eddy current and thus enhanced dynamic performance is achieved.

Cylindrical input drums 21 are secured to a drum holder 22 (also known as disc, plate, ring, etc.), with the drum holder 22 spanning the radial space between the inner magnetic core 20A and the outer magnetic core 20B. In an embodiment, the drums 21 are in a tight-fit assembly in channels of the drum holder 22 and dowel pins 23 pass through all drums 21. The dowel pins 23 may also penetrate the inner magnetic core 20A, as shown in FIGS. 3 and 4. The drum holder 22 may consist of a non-ferromagnetic material to minimize the magnetic field passing through it and may also have a high electrical resistivity to minimize resistive loss during transient operation of the MR coupling 10.

In an example among many others, the input rotor 20 may be driven by a power source through a driving gear, or any other driving member, like a chain sprocket, a belt, a friction device. For illustrative purposes, a gear portion 24 is provided for interconnection with a gear (not shown), the gear portion 24 being a toothed gear for cooperation with a driving gear. The gear portion 24 may be tight-fitted or glued or positively locked to the outer magnetic core 20B, using mechanical fasteners, or the like.

A cover 25 is fixed to the outer magnetic core 20B, and in an embodiment made of aluminum for cooling purposes. Thermal fins 25A may be present on the cover 25 so that the MR fluid coupling 10 is cooled down by forced convection when the input rotor 20 rotates. The thermal fins 25A help to decrease the operating temperature of the MR fluid and may thus improve the life of the MR fluid coupling 10. The cover 25 may press a face static seal 25B onto the outer magnetic core 20B to prevent MR fluid leakage. Fill ports 25C may be defined through the cover 25, to fill the MR fluid coupling 10 with MR fluid. As illustrated, the fill ports 25C may be tapped and plugged using sealed set screws 25D among other solutions.

A central hole 25E in the cover 25 is closed by an expansion chamber cap 26A equipped with a flexible membrane 26B to allow MR fluid expansion during either temperature increase or MR fluid phase transition when aged. To counter the bulging of the membrane 26B due to the MR fluid, some compliant material, such as polyurethane foam, may be placed in the empty expansion volume between the expansion chamber cap 26A and the flexible membrane 26B. The compliant material therefore exerts a biasing pressure on the membrane 26B. Also, a vent hole may be present in the expansion chamber cap 26A to avoid excessive pressure build up in the empty expansion volume. Expansion chamber 26 may also be formed with a compressible material (e.g., closed cell neoprene) that may take less volume as the pressure increases in the MR Fluid F. If a compressible material is present, the expansion chamber may not need a vent hole and may not need a membrane 26B.

Still referring to FIGS. 5 and 6, the stator 30 is made of a ferromagnetic material to guide the magnetic field. The stator 30 may have an annular body with an annular cavity 30A formed in its U-shaped section. The inner magnetic core 20A is received in the annular cavity 30A, which may be defined by an inner annular wall 31A, an outer annular wall 31B, and a radial wall 31C, all of which may be a single monolithic piece. The inner magnetic core 20A is rotatably supported by one or more bearings 32, a pair being shown in FIGS. 3 and 4. Although the bearings 32 are shown located between the inner magnetic core 20A and the stator 30, inward of the inner magnetic core 20A, it is considered to position the bearings 32 elsewhere, such as in radial fluid gaps described below. The stator 30 is for instance connected to a structure via bores on its outer face 33 (that is part of the radial wall 31C), and is thus the immovable component of the MR fluid coupling 10 relative to the structure.

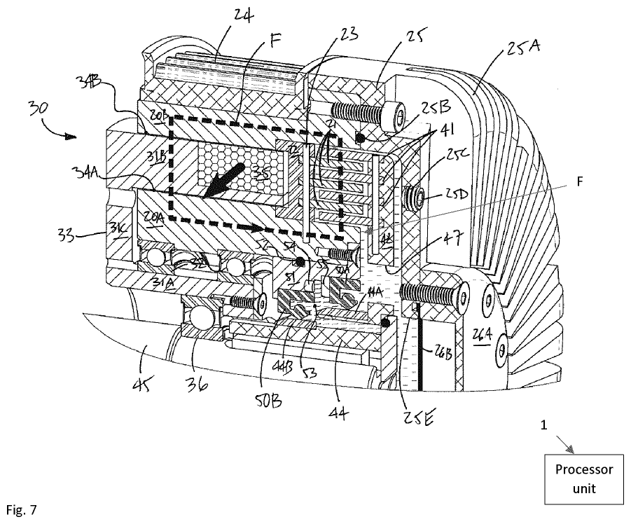

As best seen in FIG. 7, the stator 30 is sized such that radial fluid gaps 34A and 34B may be defined between the stator 30, and the inner magnetic core 20A and outer magnetic core 20B, respectively. The radial fluid gaps 34A and 34B, during use, are filled with a fluid, such as air and other gases, or lubricating and/or cooling liquids like oil, grease, etc. Hence, the radial fluid gaps 34A and 34B are free of solids during use. Coil 35 is secured to the annular body of the stator 30, for instance using an adhesive. It is contemplated to provide a slot through the stator 30 for passing wires connected to the coil 35, for powering the MR fluid coupling 10. The stator 30 further comprises one or more bearings 36 for rotatably supporting the output rotor 40, as described hereinafter.

The coil 35 may be wound using a high copper factor winding method. A higher copper ratio may lead to improved efficiency. Also considered are winding methods allowing flat wire winding, horizontal stacking, cylindrical stacking, for example. Multilayer PCBA winding is also considered (Heavy Copper PCBA) instead of copper only.

The bearings 32/36 are greased and may use no-contact seals to limit friction loss. The bearing arrangement featuring bearing(s) between the input rotor 20 and the stator 30, and separate bearing(s) between the stator 30 and the output rotor 40 enhances the safety of the MR fluid coupling 10. For example, if the input rotor 20 is jammed with the stator 30, the output rotor 40 is still free to rotate. Inversely, if the output rotor 40 is jammed with the stator 30, the power source that drives the input rotor 20 can still rotate.

The output rotor 40 has cylindrical output drums 41 that are secured to a drum holder 42 (e.g., plate, disc, etc.) by a tight-fit assembly on the inner diameter of the drums 41. Dowel pins 43 may pass through the drums 41, among other ways to connect the output drums 41 to the drum holder 42. The output drums 41 are ferromagnetic so that the magnetic field easily passes through them (for example, with an equivalent magnetic flux in each of the drums). The drum holder 42 is made of a non-ferromagnetic material to minimize the magnetic field passing through it, like an aluminum alloy, to reduce the inertia of the output rotor 40.

The drum holder 42 has a shaft interface 44 by which it is connected to a shaft 45. In an embodiment, the shaft interface 44 is a sleeve-like component that is rotationally coupled to the shaft 45, and may have wear sleeves 44A and 44B. The output rotor 40 is locked in rotation to the output shaft 45 by a key or any other locking device (splines, tight-fit, etc. . . . ). A sealed shaft cap 46 is used to axially maintain the output rotor 40 relatively to the output shaft 45 and to prevent MR fluid leakage. A flat portion for a key may be defined on the output shaft 45 to ease screwing the shaft cap 46. This arrangement is one among others to connect the drum holder 42 to the shaft 45, such that the shaft 45 may receive the driving actuation from the input rotor 20 via the drum holder 42. The drum holder 22 further comprises throughbores 47 that may be circumferentially distributed therein to allow MR fluid circulation. As shown in FIGS. 3 and 4, the throughbores 47 are between the drums 41 and the shaft interface 44.

The MR fluid coupling 10 of FIG. 4 may be said to be a multi-turn, in that the output rotor 40 is not limited to the number of rotations it can do relative to the stator 30. Indeed, in an embodiment, all power wires and connections are connected to the stator 30, with the output rotor 40 not constrained from rotating by any connection relative to the powering.

The MR fluid coupling 10 may use an odd number of drums 21 and 42, for example a mean value of about 7. More or fewer drums may be used according to the application. Using more than one drum helps to decrease the overall volume and weight of the MR fluid coupling 10 for a given desired torque and a given diameter, as using multiple drums helps to reduce both the drum length and the cross-sections of the inner magnetic core 20A and the outer magnetic core 20B. In the same time, the time response of the magnetic circuit may be improved because the Eddy currents are minimized when the cross-sections of the magnetic cores are lower.

Referring to FIG. 7, the magnetic field F induced by the coil 35 follows a closed path which goes through the annular wall 31B of the stator 30, the radial fluid gap 34B, the outer magnetic core 20B, the MR fluid, the drums 21 and 41, the inner magnetic core 20A, and the radial fluid gap 34A. The radial fluid gaps 34A and 34B allow the coil 35 to be energized without the use of slip rings. In fact, the typical friction slip rings are replaced by magnetic slip rings performed by the two radial fluid gaps 34A and 34B. The radial fluid gaps 34A and 34B are radial rather than axial for two reasons. Firstly, radial tolerance is readily reached so that the fluid gaps can be quite small (<0.2 mm) and thus the additional number of turns in the coil required to magnetize the fluid gaps 34A and 34B is minimized. Secondly, the magnetic attractive force in the fluid gaps 34A and 34B between the stator 30 and both magnetic cores 20A and 20B is nearly cancelled due to the rotational symmetry of the fluid gaps 34A and 34B. If the fluid gaps were axial, higher magnetic attractive forces would be present and would load the bearings axially.

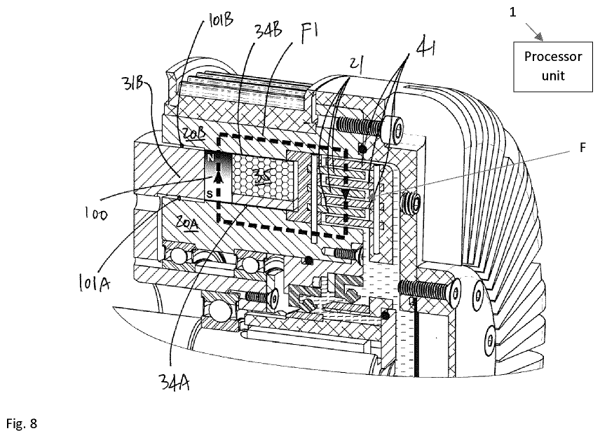

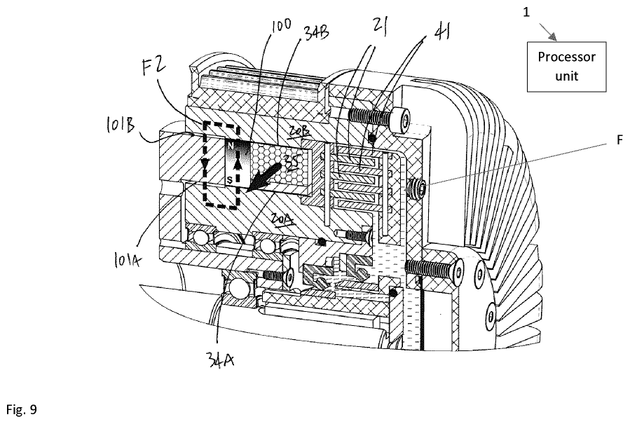

Referring to FIGS. 8 and 9, the MR fluid coupling 10 is shown in yet another embodiment. The MR fluid coupling 10 of FIGS. 6 and 7 has numerous similar components with the MR fluid coupling 10 of FIGS. 3 to 6, whereby like elements will bear like numeral references, and their description is not duplicated unnecessarily herein. A distinction lies in the presence of a permanent magnet 100 in the outer annular wall 31B, in addition to the coil 35.

As shown in FIG. 8, permanent magnet 100 is used to generate a magnetic field F1 in the MR fluid coupling 10 so that the apparatus 10 can transfer a constant output torque without the need to apply a current via the coil 35. The permanent magnet 100 is radially magnetized and may be a full solid annular part or an assembly of individual magnets (such as cylindrical magnets). Other radial fluid gaps 101A and 101B, “redirection gaps”, separate the part of the annular wall 31B on the opposite side of the permanent magnet 100 than the coil 35, from the inner magnetic core 20A and the outer magnetic core 20B.

When no current is applied to the coil 35, as in FIG. 8, magnetic field F1 is present in the MR fluid according to the described magnetic flux path shown. Some magnetic flux circulates through the other radial fluid gaps 101A and 101B, separating the stator 30 from the inner magnetic core 20A and the outer magnetic core 20B. These gaps 101A and 101B are a bit wider than the gaps 34A and 34B, the width being in a radial direction. The width of the redirection gaps 101A and 101B controls the amount of magnetic flux desired in the MR fluid, a.k.a. the desired constant torque when no current is applied to coil 35. If the redirection gaps 101A and 101B are sufficiently wide, almost all the magnetic flux induced by the permanent magnet 100 goes through the MR fluid, leading to a high DC torque. If the redirection gaps 101A and 101B are radially narrower, the magnetic flux is shared between the MR fluid and the redirection gaps 101A and 101B, leading to a lower DC torque.

When a current is applied in the coil 35 according to the direction shown in FIG. 9 and the indicated polarity of the permanent magnet 100, the magnetic flux induced by the permanent magnet 100 is redirected in the redirection gaps 101A and 101B as shown by F2, which leads in a decrease of the torque of the MR fluid coupling 10. At a certain intensity of the coil current, the magnetic flux F1 in the MR fluid can be nearly cancelled and passed this intensity, it will increase again. The width of the redirection radial fluid gaps also controls the size of the winding of the coil 35. If the width is high, a bigger winding is required to redirect the magnetic flux.

If the current is applied in the reverse direction, the coil 35 assists the permanent magnet 100 in the generation of magnetic flux in the MR fluid, leading to the increase of the torque of the MR coupling 10.

Accordingly, the MR fluid coupling 10 has a normally “on state” for the MR fluid, because of the magnetic field induced by the permanent magnet 100. The coil 35 may then be powered to cause the MR fluid coupling 10 to reduce torque transmission and eventually be in an off state. This arrangement is useful for example when the MR fluid coupling 10 must maintain torque transmission in spite of a power outage. The magnetic field of the permanent magnet 100 would be of sufficient magnitude for the MR fluid coupling 10 to support a load without being powered.

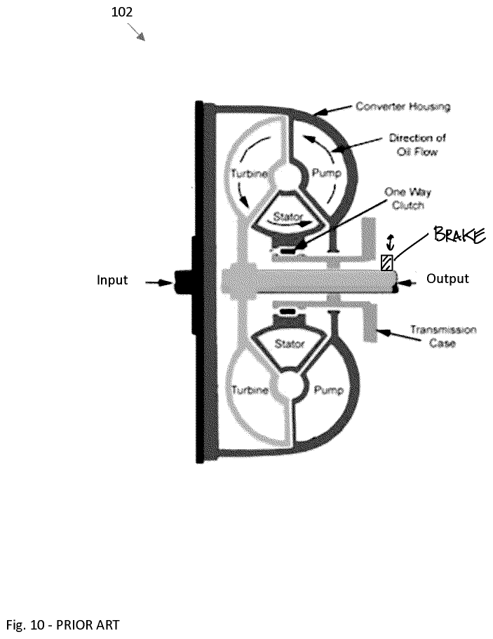

FIG. 10 depicts a cross section of a prior art fluidic torque converter 102. In the torque converter, a stator redirects oil flow, so that it assists an impeller. It can only spin in one direction, against the turbine oil flow. At low input speeds, achieved for example by controlling the speed of the torque source, also referred to herein as power source, motor, etc., the turbine turns at a lower speed than the pump, producing a gain in output torque. This arrangement is well suited to provide more torque at low input RPM and this is known as torque multiplication. As engine speed increases, torque multiplication reduces until the speed of the turbine approaches that of the pump. The stator may be mounted on a one-way clutch so it may start turning with the turbine connected to the output to limit the restriction and the losses. The stator alters the input's characteristics especially in high slippage occurrences, so as to produce an increase in output torque. Accordingly, the torque converter 102 has the capacity of multiplying torque, in a continuous manner (i.e., as opposed to torque increase in fixed ratios). As alternatives to oil, the torque converter 102 may have liquids with a low kinematic viscosity, e.g., lower than that of water, such as but not limited to methyl derivatives (methanol, methyl acetate, methyl iodide and others), organic solvents (toluene, acetone, xylene, and others), ammonia, light hydrocarbons (butane, pentane, hexane, gasoline), and mercury.

The torque converter 102 may be monitored by a torque sensor on its output to determine the amount of torque that is output by the torque convertor 102. Speed sensors may also be present at any location on the input (or upstream thereof such as on the power source/motor) and/or on the output. In order to control the torque that is output by the torque convertor 102, different actions may be taken, individually or in combination. A braking force may be applied to the output (turbine, shaft thereof) of the torque converter 102. An input speed may be increased, e.g., by increasing the motor speed. The rotation of the stator may be adjusted to change fluid transmission characteristics.

The torque converters 102, and other such hydrodynamic couplings, are particularly interesting because they have torque densities in the 100 to 300 N·m/kg, which may be higher than magnetorheological type couplings, such as MR fluid couplings 10. Hydrodynamic couplings 102 here refer to either classic hydrodynamic couplings (1 to 1 torque transfer) or variants thereof, such as torque converters 102 (up to ˜5 to 1 torque transfer).

A hydrodynamic coupling classically consists of a pump (input) and a turbine (output). The spinning action of the pump provides kinetic energy to a fluid, that is then transferred to a turbine connected to the coupling's output shaft. The input torque may generally be equal to the output torque, but the input speed may be faster than the output speed to compensate for system losses. The output torque is as a function of the input torque, input speed, output speed and machine efficiency map.

The torque converter 102 is a special configuration of a hydrodynamic coupling, that typically consists of a pump (input), a turbine (output), and a third member, i.e., a reactor added between the pump and turbine. The reactor may be a fixed device, a free-wheeling device or a device mounted on a one-way clutch as shown in FIG. 10, connected to the casing to redirect the fluid exiting the turbine into the pump's inlet, therefore conserving some of the exiting flow momentum. In doing so, the pump may spin faster for the same input torque. A faster pump may result in more torque sent to the turbine. In practice, the torque multiplication effect provides output torques that may be up to ˜5 times higher than the input torques. Here again, the input speed is faster than a perfectly reversible system with a similar torque multiplication to compensate for system losses. The output torque is as a function of the input torque, input speed, output speed and machine efficiency map. Torque converters have been proposed with many topological variants having different numbers of pump, turbines, and reactors. A variant used in the industry is the Trilok converter consisting of one pump, one turbine, and one reactor. Any such torque converters may be used in the additive parallel load path actuators described herein.

Analysis of the torque density of geometrically similar couplings shows that the torque-to-mass ratio of hydrodynamic couplings such as hydrodynamic couplings and torque-converters is size invariant and scales with the square of the device's tip linear speed: T/m α v² where “v” is the tip speed of fluid at the working diameter. The torque-to-mass ratio of friction couplings based on magnetorheological fluids decreases with size and is found experimentally to vary such that: T/m α D^{a} where “a” is around one, and more precisely within the range [0.8-1.3] and “D” is a characteristic dimension of the unit such as its diameter. The size dependence is due to the detrimental effect of the magnetic circuit at small scales. With current technology, it is estimated that a 1 N·m MR fluid coupling can weight 150 gr while a 1 N·m hydrodynamic coupling can weigh between 15 to 30 gr, providing a 5 to 10×advantage.

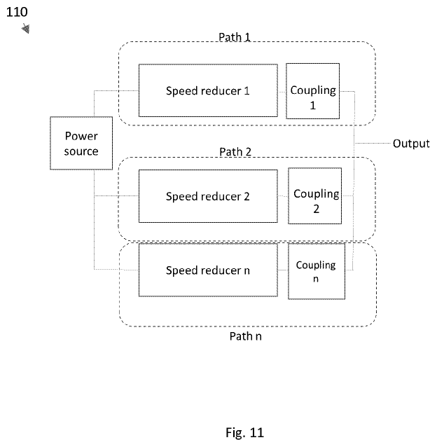

Referring to FIG. 11, a parallel load path actuator in accordance with the present disclosure is shown at 110. The parallel load path actuator 110 may combine the torque of low inertia actuators using fluidic coupling 1, fluidic coupling 2 and optionally fluidic coupling n each coupled to a respective speed reducer 1, 2 and n. Fluidic coupling 1, fluidic coupling 2 and fluidic coupling n (if present may be a torque converter 102 type or a MR fluid clutch coupling 10. Fluidic couplings 1, 2 and n may all be of torque converter 102 type. Fluidic couplings 1, 2 and n may also all be MR fluid coupling 10 type. Fluidic couplings 1, 2 and/or n may be of different types, one or more of torque converter 102 type and the other or more of MR fluid coupling 10 type. Instead of a fluid coupling, a Sprag clutch, or like one-way freewheeling clutch may be used, in one of the parallel load paths. These fluid couplings can be applied to variants described below with respect to FIGS. 11′, 12, 12′, or other embodiments described herein. Fluidic couplings may be placed between their respective speed reducers and the common output, though the speed reducers may be absent in some of the paths. The speed reducers described herein may be part of a transmission and may be transmission components (e.g., gears, pulleys and belts, chains and sprockets) that cause a change of speed between the power source and the input of the fluidic couplings 1, 2 and/or n. For simplicity reasons, systems with two additive parallel paths are shown but additional n parallel paths may be added. The additive parallel load path actuator 110 may use parallel load paths where the torque transmitted in each load path 1 and 2 may be scaled (e.g., different ratios) to different requirements. The actuator 110 may use solely the load path 1, and solely the load path 2, meaning that torque is transmitted only by one or the other of the two load paths, 1 and 2. The actuator 110 may be said to be additive, meaning that both load paths 1 and 2 can transfer torque simultaneously for uninterrupted torque modulation. Path 1, path 2 as well as additional path n may be connected to a shared power source. The actuators described herein have such capacity. The power source in this variant and in other variants described herein may be an electric motor or electric machine, an engine, a combustion engine, a transmission, pneumatic or hydraulic actuators, turbine, among many other possible power sources. The additive torque feature is possible because of the controllable slippage of fluid couplings of either torque converter 102 type or MR fluid coupling 10. Without slipping of the fluidic couplings, the n paths would provide antagonistic forces one against the other and would not be additive.

FIG. 11′ depicts an alternative possible arrangement of additive parallel load path actuator where the torque converter 102 type or MR fluid coupling 10 may be installed between the power source and the paths 1, 2 and n or after. Alternatively, couplings 1, 2, n may be installed such that one or more are before the speed reducers and the other(s) is after the speed reducers (if present). This arrangement provides the same additive torque advantage as the additive parallel load path actuator shown at FIG. 11.

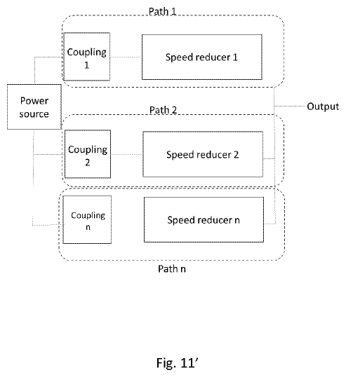

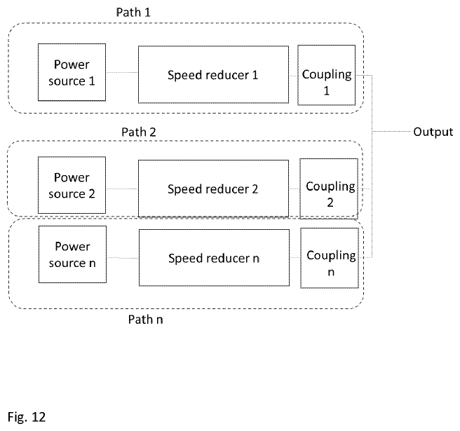

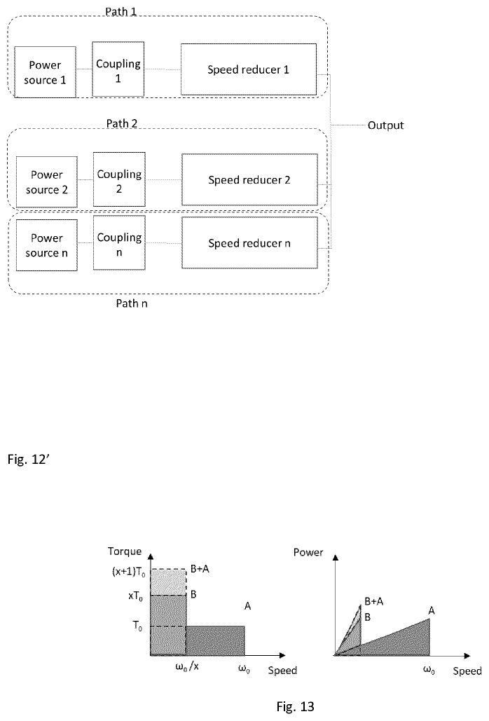

FIG. 12 illustrates a similar system as the one shown in FIGS. 11 and 11′, but with the difference that both path 1, path 2 and path n (if present) are connected to individual power sources. Although not shown, such a system could have a shared power source for multiple power paths (e.g., paths 1 and 2 with a common power source) and additional independent power sources for some other paths (e.g., path n with its own power source), with all load paths sharing a common output providing the additive torque.

FIG. 12′ shows various possible arrangements of additive parallel load path actuators where the fluidic couplings (e.g., a torque converter 102 type or MR fluid coupling 10) may be installed between the power sources and the paths 1 and 2, or after. Alternatively, couplings 1 and 2 may be installed such that one is before the load path and the other is after the load path.

As shown in FIG. 13, the additive parallel load path actuator distinct load paths from a single power source to a single output using multiple couplings 1, 2, n such as in FIG. 11 and FIG. 11′. A parallel load path actuator may also be an actuator that combines distinct load paths from multiple power sources to a single output using multiple couplings 1, 2, n such as in FIG. 12 and FIG. 12′. In each case, each load path may produce a different torque, speed or power at the coupling. Each load path may also be driven by different power sources. In comparison with a traditional prior art multi-geared actuator such as shown in FIG. 2, the use of a fluidic coupling of either torque converter 102 type or MR fluid coupling 10 allows the combination of each load path simultaneously to produce a given torque, speed or power at the single output, without interruption (ex: shifting). FIG. 13 shows an exemplary energetic description of a parallel load path actuator. In the specific case shown in FIG. 11 (with two load paths 1 and 2), the maximal torque output of the system (B+A) is the sum of the torque A generated by load path 1 and the torque B generated by load path 2. The load path that turns faster can add its torque to the other that turns slower, as the fluidic couplings perform slipping. The total output power of the system is increased accordingly.

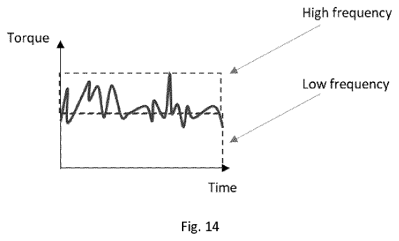

Magnetorheological clutches or couplings are particularly interesting to make a reactive additive parallel load path actuator 110. The fluidic interface of MR fluid coupling 10 allows high slippage rates for long periods, while decoupling the actuator dynamics from the output. Moreover, MR fluid coupling 10 has low inertia and high bandwidth. By using a parallel load path actuator with MR fluid couplings 10 as couplings 1 and/or 2, a mechanical system may be optimised at different conditions. For instance, path 1 may be optimised to control a large amplitude, low frequency signal, while path 2 may be optimised to control the high frequency signal, such as shown in FIG. 14. A particular advantage may be to control the high torque, low frequency component with a low slip in MR fluid coupling 1 order to maximise the durability of the fluid (e.g., using a MR fluid coupling 10 as in FIGS. 8 and 9). Since the load path 2 may be summed to the load path 1, the load path 2 may be optimised for high speed response (ex: by turning faster than the load path 1). When the dynamics response of the additive parallel load path actuator cannot be meet by path 1, path 2 can add its torque to path 1 in order cope with this situation. A smooth transition between path 1 and path 2 may be obtained because of the high bandwidth response of the fluidic coupling of type MR fluid coupling 10. In an embodiment, the torque graph of FIG. 14 is representative of an additive parallel load path actuator 110 that has a torque convertor 102 in a first load path, and a MR fluid coupling 10 in the second load path. The load path featuring the torque convertor 102 would provide the low frequency portion of the torque, while the load path including the MR fluid coupling 10 would provide torque at high frequency variations. In such an arrangement, the torque convertor 102 and the MR fluid coupling 10 operate in complementary fashion, in that the torque convertor 102 could multiply the torque (i.e., cause a torque increase between its input and output), while the MR fluid coupling 10 could adapt the cumulative output of the additive parallel load path actuator 110 to meet a varying torque demand. There could result an output with greater torque density than if two MR fluid clutch apparatuses 10 were used, while maintaining a high bandwidth.

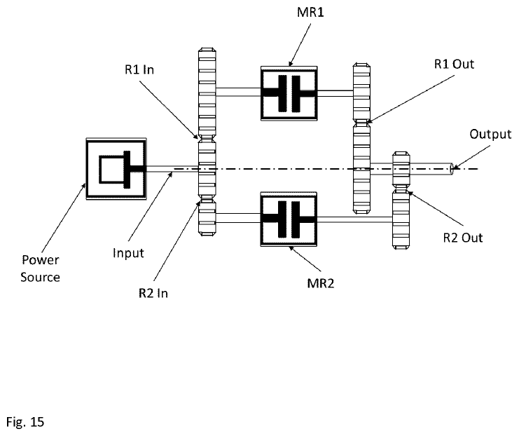

FIG. 15 illustrates a basic configuration of an additive parallel load path actuator using magnetorheological fluid couplings (such as MR fluid clutch apparatuses 10) to connect the load at the output to a power source. The two load paths are mechanically connected at their input and output. Reduction mechanisms such as belts, gears, cables, traction drives, hydrostatic drives can be used either on the input or output side or both as needed (e.g., as in FIGS. 12 and 12′) to adjust torques and angular velocities to desired levels such that gearing ratios R1,In R1, Out R2, In R2, Out are selectable design parameters. Transmitted torque in each load path is controlled by varying the magnetic field of the magnetorheological fluid couplings MR1 and MR1 and by controlling the speed of the power source.

Considering that secondary losses may be neglected, that the power source direction can be controlled at will, that the magnetorheological fluid couplings each have a maximum torque of “+/−T” in both directions, that the ratios are selected such that R1, In=R2,In and R1, Out=2×R2, Out, then, if each parallel load path is used independently, the maximum torque of the additive parallel load path actuator of FIG. 15 is about −T to +T and about −2T to +2T. If both load paths are used simultaneously with sufficient slippage, then the overall torque capability of the additive parallel load path actuator of FIG. 15 is about −3T to +3T.

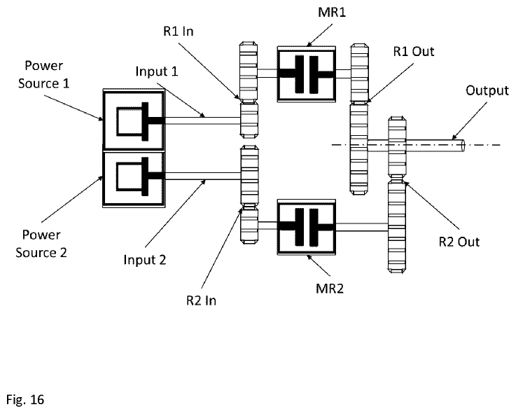

FIG. 16 depicts a variant of the basic configuration of FIG. 15 and also shows an additive parallel load path actuator using parallel load paths with magnetorheological couplings, but the load paths are only mechanically connected at their output. The inputs load path 1 and load path 2 are independent, and each connected to its own power source. Reduction mechanisms such as belts, gears, cables, traction drives, hydrostatic drives can be used either on the input or output side or both (e.g., as in FIGS. 12 and 12′) as needed to adjust torques and angular velocities to desired levels such that gearing ratios R1,In R1,Out R2,In R2,Out are selectable design parameters. Transmitted torque in each load path is controlled by varying the magnetic field of the magnetorheological fluid couplings 10 and by controlling the speed of the two power sources.

Considering that secondary losses may be neglected, that the power source direction can be controlled at will, that the magnetorheological fluid couplings each have a maximum torque of “+/−T” in both directions, that the ratios are selected such that R1, In=R2,In and R2,Out=2×R1, Out, then, if each parallel load path is used independently (path 1 OR path 2 BUT NOT path 1 AND path 2), the maximum torque of the device is respectively about-T to +T for path 1 and about −2T to +2T for path 2. If both load paths are used simultaneously (path 1 AND path 2) with sufficient slippage, then the overall torque capability of the additive parallel load path actuator of FIG. 16 is −3T to +3T.

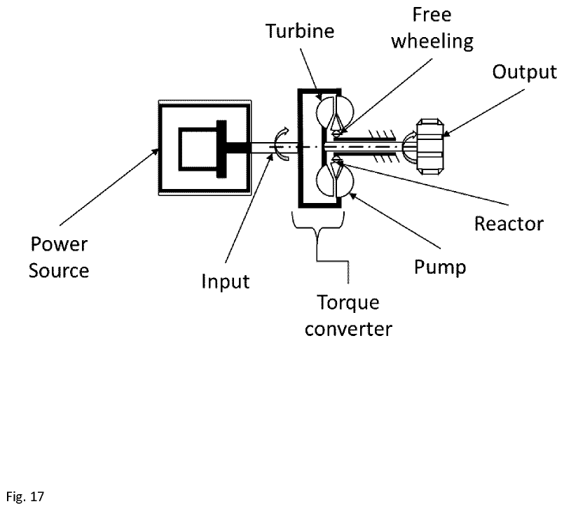

FIG. 17 shows an hydrodynamic coupling of torque converter type 102. Since couplings of torque converter type 102 can multiply torque internally, they do not require a parallel load path and can be used alone, placed between a power source (here an electric motor) and an output (here a simple shaft). Reduction mechanisms such as belts, gears, cables, traction drives, hydrostatic drives can optionally be used either on the input or output side or both as needed to adjust torques and angular velocities to desired levels. Transmitted torque is controlled in open-loop by controlling the angular velocity of the power source in relation to the angular velocity of the output while correlating with the performance map of the coupling. Alternatively, a torque sensor can be used on the output and a feedback controller can be used to control the speed or torque of the power source. Whether in open or closed loop, the time response of a torque converter to a change in torque command is expected to be slower (e.g., 1-2 Hz) when compared to a MR fluid coupling 10 (e.g., 100 Hz) because hydrodynamic couplings require a speed change of the input followed by a speed change of the fluid inside the coupling before a change in torque is felt. In contrast, MR fluid couplings such as 10 only demand a change of magnetic field in the control coil, which enables the high bandwidth (e.g., 100 Hz). Considering that secondary losses are neglected, that the power source direction can be controlled at will, that the path of the torque converter has a maximum torque “3T” in its design direction and a minimum torque “−T” when rotating backward from the design direction, then, the overall torque capability of the actuator in FIG. 17 when the output is blocked (i.e., not freewheeling) is −1T to +3T.

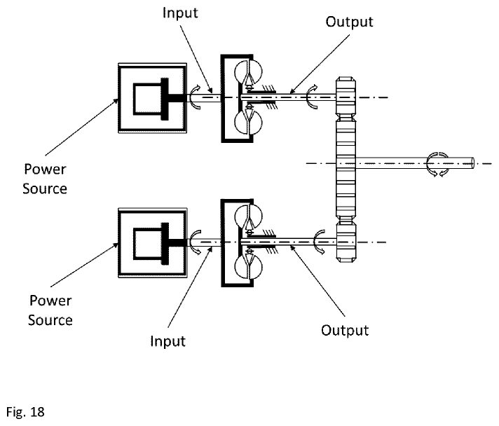

FIG. 18 shows an additive parallel load path actuator combining multiple sub-assemblies of power sources with hydrodynamic couplings used to increase overall torque. FIG. 18 shows two sub-assemblies, each consisting of one power source and one torque converter, e.g., of torque converter type 102. The torque converters can be designed to multiply torque in same or opposing directions. The load paths can have different gearing ratios. Considering that secondary losses are neglected, that the power sources directions can be controlled at will, that the paths of the torque converters have a maximum torque “3T” in their design direction and a minimum torque “−T” when rotating backward from the design direction, then, the overall torque capability of the device in FIG. 18 when the torque converters are designed to be additive (both in same direction) is −2T to +6T, when the torque converters are designed to be antagonist (opposing direction) is −4T to +4T.

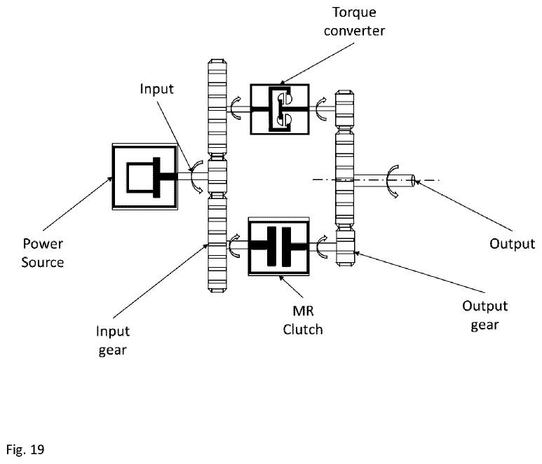

FIG. 19 illustrates an additive parallel load path actuator that is a combination of a hydrodynamic coupling (e.g., of torque converter type 102) in parallel with one or more MR fluidic couplings 10. However, other type of couplings, hydrodynamic couplings, electrorheological couplings, or mechanical friction wet clutches may be used. The combination of FIG. 19 presents the benefit of having internal torque multiplication effects of the fluidic coupling of torque converter 102 type, external torque addition effects of the parallel load paths, and high bandwidth controllability of the MR fluid coupling 10. In this configuration, the torque converter may handle most of the torque demand while the magnetorheological fluid coupling 10 may fine tune the torque by adding (or subtracting if MR fluid coupling 10 input turns slower than torque converter coupling output) its torque to accurate levels at high bandwidth. The coupling of torque converter type 102 and MR coupling 10 may be designed to add torque, subtract torque, or even apply torque in different directions. The load paths can have different gearing ratios and use any gearing technology. Considering that secondary losses may be neglected, that the power source direction can be controlled at will, that the path of MR fluid coupling 10 has a maximum torque “T” and a minimum torque “−T”, that the path of torque converter has a maximum torque “3T” in its design direction and a minimum torque “−T” when rotating backward from the design direction, then, the overall torque capability of the device in FIG. 19 when the torque converter and MR fluid coupling 10 are acting collaboratively and the output is blocked is −2T to +4T.

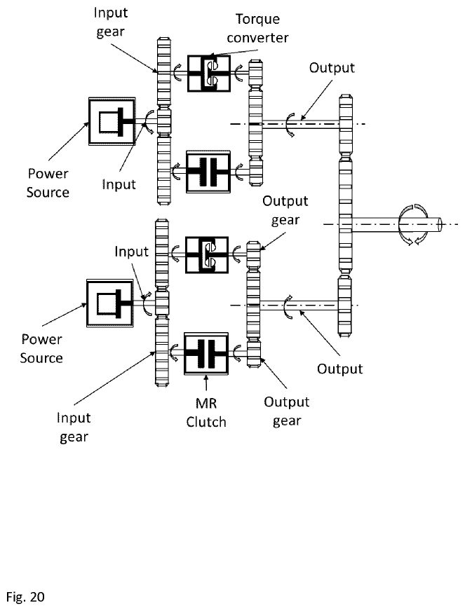

FIG. 20 illustrates an additive parallel load path actuator that is a combinations of multiple sub-assemblies of power sources, hydrodynamic couplings, and other fluidic couplings that can be used to increase overall torque. FIG. 20 shows two sub-assemblies (but more possible), each sub-assembly consisting of one torque converter (e.g., 102 type) and one MR fluid coupling 102. The torque coupling of torque converter type 102 are designed to apply and multiply torque in opposing directions. Considering that hydraulic losses may be neglected, that the power sources directions can be controlled at will, that the paths of the MR fluid clutches 10 have a maximum torque “T” and a minimum torque “−T”, that the paths of the torque converters have a maximum torque “3T” in their design direction and a minimum torque “−T” when rotating backward from the design direction, then the overall stall torque capability of the additive parallel load path actuator of FIG. 20 when all motors, torque converter and MR clutches are acting collaboratively is +/−6T.

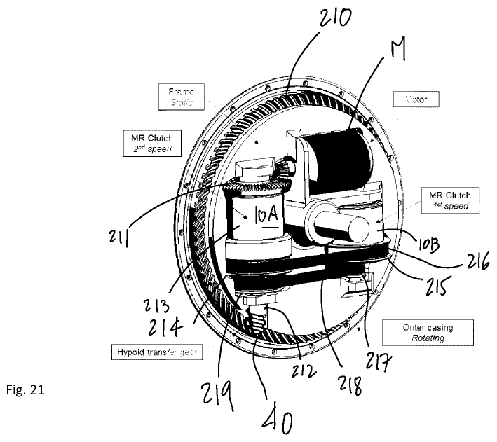

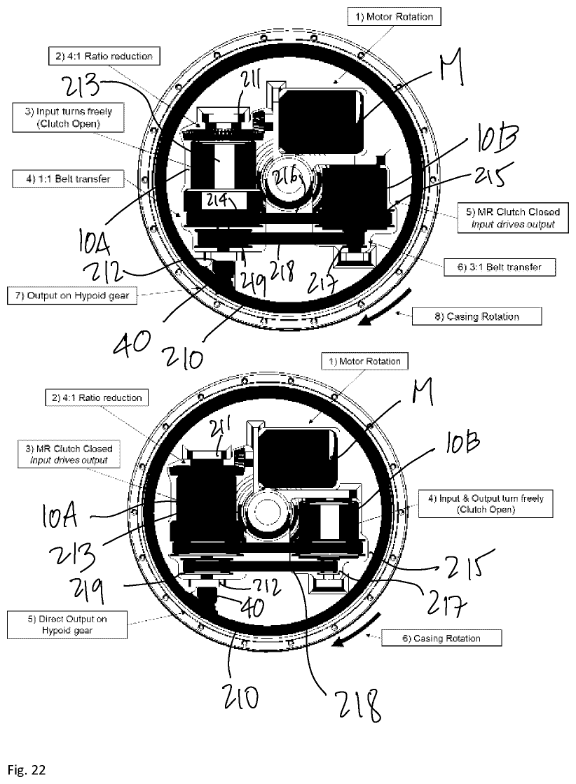

FIG. 21 shows a wheel motor using an additive parallel load path actuator in accordance with an embodiment of the present disclosure. The wheel motor uses two fluidic coupling of MR 10 type, but could also use torque converters 102 instead of one or both of the MR fluid couplings 10. For simplicity, the embodiment of FIG. 21 will be described with reference to MR fluid couplings 10, but the description extends to torque converters 102. Torque may be transmitted across two load paths using MR fluid coupling 10A and MR fluid coupling 10B. Both MR fluid couplings 10A and 10B may be controlled with high bandwidth (>30 Hz). By combining two MR fluid couplings on a single output 40, as shown in FIG. 21, a multi-speed powertrain may be created. The powertrain consists of a single power source, in occurrence a motor M, two load paths, and two rotating MR fluid couplings 10 that can drive a common output device 40. The common output device 40 is the hypoid transfer gear (or like spiral bevel gear such as a spheroid gear), as an example among others, and as shown coupled to the ring gear 210, being for example a crown gear as shown. The output may be a spiroid, worm gear, a spur gear, a pulley, a chain ring, etc., as examples among numerous others. A first load path consists of the input of MR fluid coupling 10A of the 2^{nd} speed, shown as a bevel gear 211 coupled to the motor M, and the output 212 of the MR fluid coupling 10A of the 2^{nd} speed that is driving the hypoid transfer gear 40. The bevel gear 211 is rigidly connected to the outer casing 213 of the MR fluid coupling 10A of the 2^{nd} speed, such that they rotate concurrently. MR fluid in the MR fluid coupling 10A of the 2^{nd} speed can adjust slippage so as to control the rotation of the hypoid transfer gear 40. As observed, a pulley 214 is provided on the outer casing 213 of the MR fluid coupling 10A of the 2^{nd} speed, such that they rotate concurrently. The pulley 214 is operatively connected to a pulley 215 of the MR fluid coupling 10B of the 1^{st} speed using a belt 216, but other transmission types are possible (gears, chain and rings, etc.). A second load path consists of an input of the MR fluid coupling 10A of the 2nd speed, transferring its torque to the input of the MR fluid coupling 10B of the 1^{st} speed using a belt speed reduction mechanism, that is transferring the torque to the output of the MR fluid coupling 10A of the 1^{st} speed, the input of the MR fluid coupling 10B of the 1^{st} speed incorporating the pulley 215 on the outer casing of the MR fluid coupling 10A of the 1^{st} speed. The second load path further includes a transfer of the torque to the output of the MR fluid coupling 10A of the 2^{nd} speed that is driving the hypoid transfer gear 40, via the pulleys 217 and belt 218, the pulley 217 being on an output of the MR fluid coupling 10B. Again, other transmission configurations are possible. Activating of the MR fluid coupling 10B of the 2^{nd} path results in a transfer of the torque by the second load path while activating the MR fluid coupling 10A of the 1^{st} load path results in actuating the 1^{st} load path. Activating the two MR fluid couplings 10A and 10B simultaneously would results in an addition of the torque generated by the two load paths, such that the power source M provides a speed that is superior to the required speed of the slower load path to cope with the wheel motor speed. If the speed of the power source is slower than the speed required by the wheel motor M, than actuating the two MR fluid couplings 10A and 10B simultaneously would reduce the available torque at the output 40 because the torque generated by the slower MR fluid coupling would provide a net torque in the opposing direction than the torque generated by the faster MR fluid coupling load path. The proposed additive parallel load path actuator may produce torque in a clockwise (CW) direction with a given ratio for the first speed (see FIG. 22 left) and activating the other MR fluid coupling produces torque in a clockwise (CW) direction with a second ratio (see FIG. 22 right). Hence, only one MR fluid coupling 10A or 10B is active, or the two MR fluid couplings 10A and 10B are active, at a given time. The control system continuously adjusts the electric current in each electromagnet of each MR fluid coupling 10A and 10B to produce the appropriate powertrain output torque required in a given situation.

The system of FIG. 21 may be described as including a torque source (motor) M; a first MR fluid coupling 10A having a first input (outer casing 213 with bevel gear 211 and pulley 214) coupled to the torque source M, and a first output 40 (hypoid transfer gear) to selectively transmit torque as a function of a control of the first MR fluid coupling 10A; a second MR fluid coupling 10B having a second input (outer casing with pulley 215), and a second output (pulley 217) to selectively transmit torque as a function of a control of the second MR fluid coupling 10B; a first transmission (e.g., belt 216) between the input of the first MR fluid coupling 10A and the input of the second MR fluid coupling; a second transmission (e.g., belt 218) between the output (via pulley 219) of the first MR fluid coupling 10A and the output (via pulley 217) of the second MR fluid coupling 10B. The system is operable to transmit torque from the torque source M to the first output via a first load path and a second load path, and possibly more. The first load path is defined by torque transmitted from the first input to the first output of the first MR fluid coupling 10A via a control of first MR fluid coupling 10A. In the first load path, while the pulley 214 may transmit torque to the second MR fluid coupling 10B, the latter is in slippage mode. The second load path is defined by torque transmitted from the first input 214 to the second input 215 via the first transmission 216, from the second input 215 to the second output 217 of the second MR fluid coupling 10B via a control of second MR fluid coupling 10B, and from the second output 217 to the first output (pulley 219 secured to the output shaft of the MR fluid coupling 10A) via the second transmission 218. In the second load path, the first MR fluid coupling 10A is in slippage mode. The system may be operable to transmit torque from the torque source M to the first output via a third load path, the third load path defined by torque being transmitted cumulatively via the first load path and the second load path.

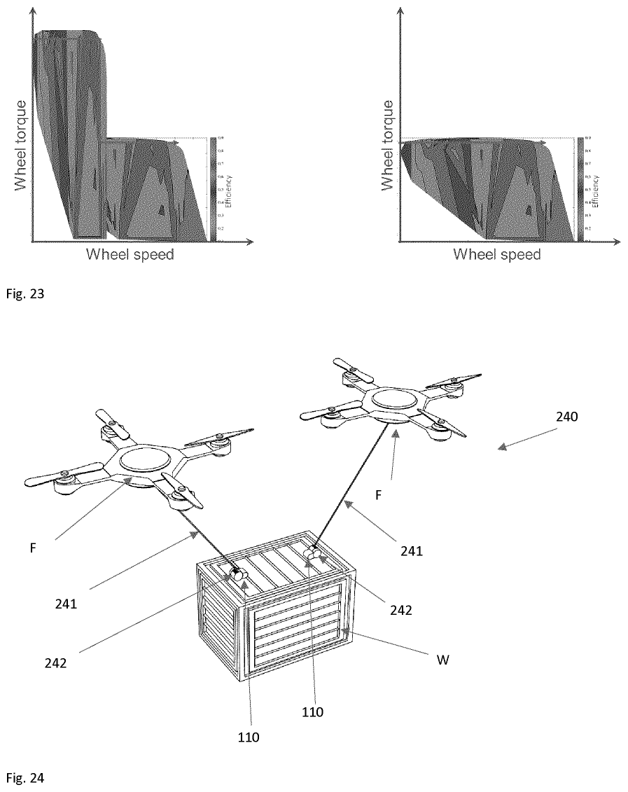

FIG. 23 (left side) shows the wheel torque versus speed graph achievable by the additive parallel load path actuator such as in any of the embodiments described herein, compared (right side) to a system where only a single load path is provided. It can be seen that the wheel torque envelope is increased at low speed by using a second load path and that the torque is uninterrupted when transitioning from one load path to the other because of the additive nature of the torque provided by the two load paths. This configuration presents the advantage of independent coupling control at each rotor output. This way, the control system can dynamically vary the rotational speed of the output by using each clutch contribution (or both if extra torque is required) to enhance safety and performance. By relying on two independents fluid coupling, such as MR fluid couplings 10A and 10B, each with its own gear ratio, the system's weight may be minimized (e.g., compared to conventional electric powertrains), since each power chain (i.e., load path), and especially each MR fluid coupling (or equivalent fluidic coupling such as torque convertor 102), is sized for roughly only half the torque (a standard system would require a motor able to provide twice the torque of the proposed additive parallel load path actuator). Also, with the high torque-to-inertia ratio of MR fluid clutches 10 or torque converters 102, this results in an actuator output inertia that is orders of magnitude less than a traditional standard motor system and that allows the packaging of multi-speed system in a relatively small volume. Moreover, constant-slippage MR fluid couplings 10 and torque converters 102 do not present the same limitations between reduction ratio and bandwidth, therefore making them complementary and well suited for low-weight, yet highly dynamic performance devices as the one described herein. In this system, torque can be transmitted in reverse direction, allowing the system to provide regenerative braking. In some systems where torque does not need to be transmitted in the reverse direction with the highest torque level, the fluid coupling device of the path with the lowest speed may be replaced by a one-way bearing (e.g., a Sprag clutch). In doing so, the smooth transition between the low speed ratio and the high speed ratio is provided by the fluidic device that has the lowest overall gear ratio and the high speed. In device system where a one-way device is used as the low speed fluidic coupling, reverse direction may only be obtained by the other path.

Referring to FIG. 24, the general configuration with the main component of the payload motion control system 240 using multiple tethers 241 (two shown, but additional tethers being possible) coupled to multiple additive parallel load path actuators (such as those described herein) each featuring one or more of the MR fluid clutch apparatus 10 (or alternatively torque convertors 102) is represented in a collaborative load lifting system 240. Due to the weight considerations in airborne uses, one or more of the additive parallel load path actuators may be of the type having a single shared power source (e.g., electric motor), such as the additive parallel load path actuators 110 of FIGS. 11 and 11′, though this is merely an option. In the case of a collaborative load lifting system 240, one or more aircraft F are tethering a payload, i.e., raising the payload against gravity. A sensor or a set of sensors (not shown) such as an inertial measuring unit (IMU) with any arrangement of accelerometer(s), gyroscope(s), inclinometer(s), etc., a global navigation satellite system (GNSS), and/or a global positioning system (GPS) may be used to detect the payload position, velocity, direction and/or acceleration. The sensor(s) may be on the payload W, on the parallel load path actuator 110, on the output 242, on the tether 241 and/or on the aircraft F. For simplicity, a sensor(s) is generally on the payload W and/or on the aircraft F, though it may be elsewhere as recited above. In reaction to any disturbance, the parallel load path actuator 110, attached to an output 242—for example in the form of a drum-connected to a tether 241, can reel in or reel out the tether 241 to provide a target tether tension to maintain the payload W at a target position. The assembly of parallel load path actuator 110, output 242 and tether 241 relies on gravity to remain taut. Given the characteristics of parallel load path actuator 110, the payload motion may be decoupled from the tethering aircraft F used to lift the payload W. If a disturbance causes a rapid change to the aircraft position, the tether tension may not be affected, and therefore, the payload may be isolated from such aircraft motion. If a variation in the tether tension is desired, the high bandwidth of the parallel load path actuators 110 may provide a rapid response. In this situation, the use of parallel load path actuators 110 used to control the tether tension in a load lifting application may minimize the undesirable payload motion with a direct control on the tether tension. The tethers 241 may have an antagonistic effect on the payload, but other biasing members or effects may be used (i.e. other types of actuator, gravity or springs). Two aircraft F are shown but multiple aircraft nF may be used to control a single payload W or multiple payloads nW. In such a collaborative load lifting system 240, it may be an advantage to have parallel load path actuator 110 that are having a first load path to support the load when there is no or little perturbation, and a second load path to support the load when there is higher perturbation. In some conditions, when there are no or little perturbation, the first load path is designed with a high reduction ratio (low output speed) may be used to support the load with little slippage. When a higher speed perturbation happens, the second load path that is designed with a lower reduction ratio (higher speed) may support the load. During operation, the first load path and the second load path may be selected with at high bandwidth and the transition from one to the other may happen at high bandwidth, allowing a contact force or tension to be produced in the tethers 241. The utilisation of the first load path and the second load path may allow the system to limit the torque in slippage, reduce the amount of heat generated in the MR clutches apparatuses 10 that is proportional to the torque generated by the according MR clutch apparatus 10 times the slippage speed of the same MR clutch apparatus, hence the aging of the MR fluid inside the according MR clutch apparatus 10. The first load path may be used most of the time to support the load with low slippage and the second load path may support the load during higher dynamics events (e.g. air perturbation) with higher slippage. Support from the first load path and the second load path may change many times per second, at high bandwidth. In this parallel load path actuator 110, the first load path and the second load path may be able to provide the same force or tension in the tether 241 but at different slippage speeds (e.g. first load path at low slippage speed and second load at high slippage speed). They may be also designed to provide different forces or tensions in the tether 241.

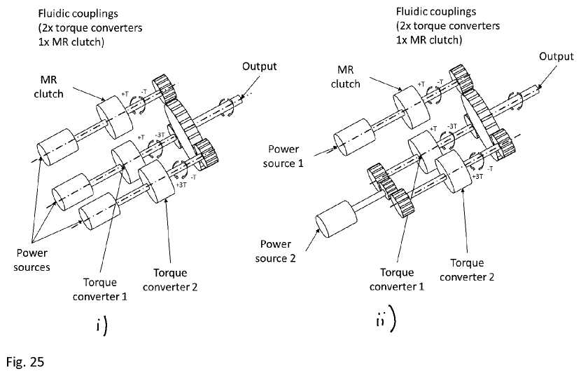

FIG. 25 illustrates an additive parallel load path actuator that is a parallel combination of multiple sub-assemblies composed of power sources, hydrodynamic couplings, and/or other fluidic couplings that can be used to increase overall torque. In FIG. 25, the additive parallel load path actuator has two arrangements of three sub-assemblies consisting of two torque converters 102 and one MR fluid clutch apparatus 10. The torque converters 102 are designed to multiply torque in opposing directions. Considering that hydraulic losses are neglected, that the power source directions can be controlled at will, that the MR fluid clutch apparatuses 10 have a maximum torque “T” and a minimum torque “−T”, that the torque converters 102 have a maximum torque “3T” in their design direction and a minimum torque “−T” when rotating backward from the design direction, then the overall stall torque capability of the additive parallel load path actuator in the two arrangements when all motors (i.e., power sources), torque converters 102 and MR clutch apparatuses 10 are acting collaboratively is +/−5T. In FIG. 25, i) shows an arrangement similar to that of FIG. 12, with three load paths and three power sources, whereas ii) shows a combination of the arrangements of FIGS. 11 and 12, with a pair of load paths having a common power source, and a third load path having its own power source.

FIGS. 26A and 26B illustrate possible torque converter topologies for the present disclosure. Regardless of these topologies, the components with most rotational inertia are preferably connected to the input of the torque converter while the components with the least inertia are preferably connected to the output. Hence it is preferred to use “wrap-around pump” constructions where the torque converter's housing (in rotation) is connected to the pump (input) leaving the turbine (output) as the sole source of rotational inertia. The first topology shown in FIG. 26A is a classic torque converter found in automotive automatic transmissions. It consists of a wrap-around pump with, from left to right, a TURBINE-PUMP-REACTOR, arrangement. The second topology shown in FIG. 26B is reversed from the classic torque converter with a REACTOR-TURBINE-PUMP arrangement. The reversed torque converter topology offers the advantage of having the mechanical seal contacting the turbine shaft riding against the pump input that is always in rotation, thereby assuring that the seal remains under dynamic friction conditions and eliminates stick-slip conditions generated by static to dynamic transitions. The friction bias caused by the turbine shaft seal can be offset by the seal of a similar torque converter of the parallel load path, but counter rotating.

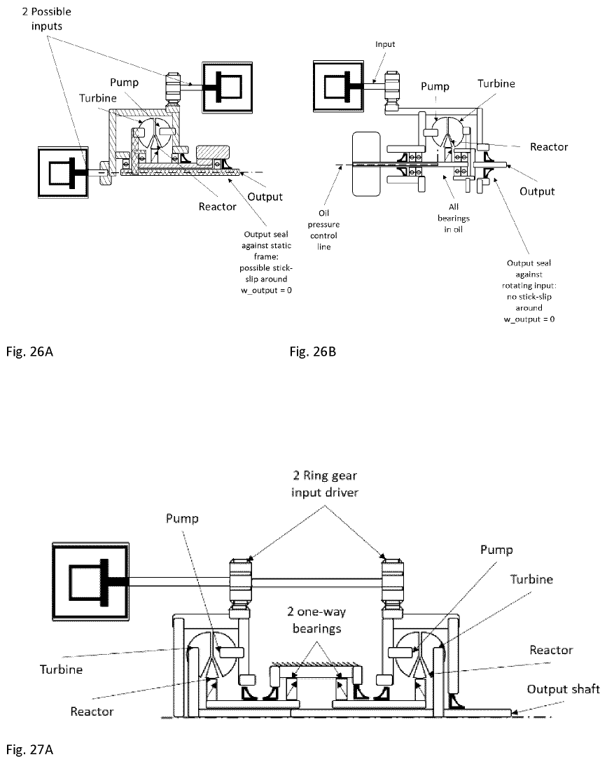

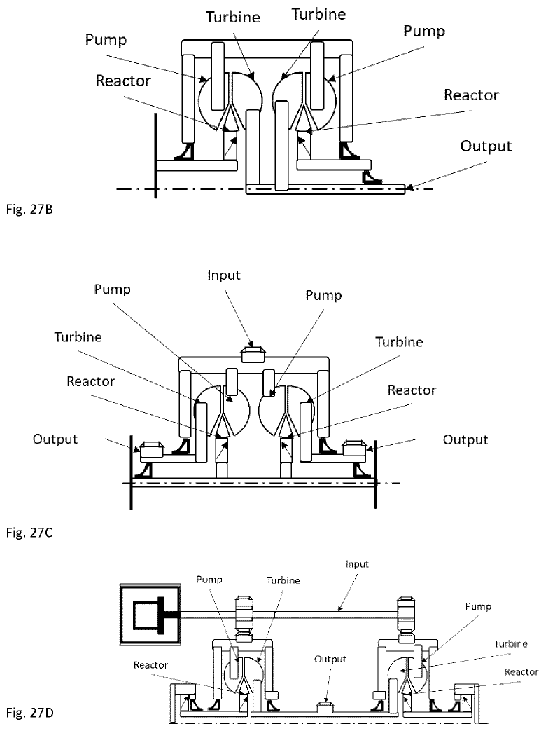

FIGS. 27A to 27D illustrate torque converters joined in parallel load paths using a modular or integrated strategy. The torque converters can rotate in opposite directions to provide bidirectional torque multiplication capabilities where one torque converter multiplies torque while the other is backdriven and vice-versa: The arrangement of FIG. 27A shows an embodiment consisting of combining two independent torque converters with input and output mechanisms. The four diagrams show embodiments where the torque converters are integrated together. The four diagrams show from left to right: A TURBINE-PUMP-REACTOR-REACTOR-PUMP-TURBINE with inner output shaft (FIG. 27A); A REACTOR-PUMP-TURBINE-TURBINE-PUMP-REACTOR with inner output shaft (FIG. 27B); A REACTOR-TURBINE-PUMP-PUMP-TURBINE-REACTOR (FIG. 27C); and. A REACTOR-PUMP-TURBINE-TURBINE-PUMP-REACTOR (FIG. 27D).

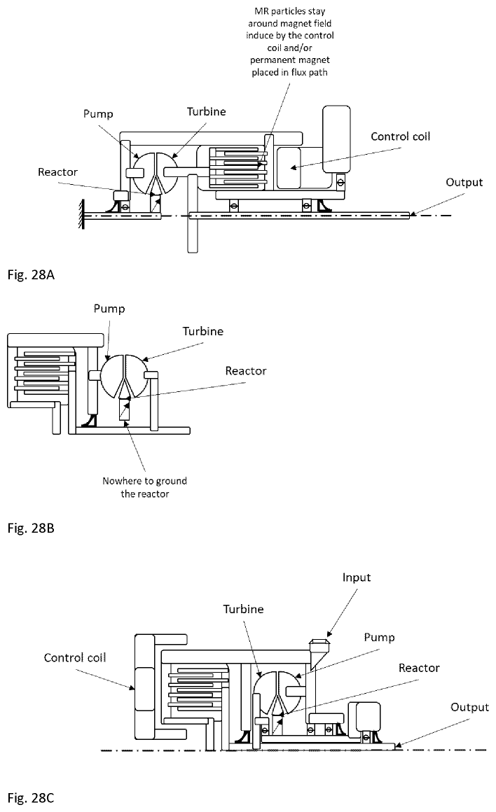

FIGS. 28A to 28C illustrate that torque converter and MR clutches can be integrated into a single unit. With such an integration, the torque converter and MR clutch share a common input and/or a common output. The figure below shows 3 relevant torque converter/MR clutch topologies sharing a common input and a common output: The first topology in FIG. 28A uses a common input member consisting of a wrap around pump torque converter connected to a set of frictional interfaces of an MR clutch (here a drum clutch). The output member is also common and consists of the torque converter's turbine connected to other set of frictional interfaces of the MR clutch. From left to right, the key components are: PUMP-TURBINE-MR. In this embodiment, both devices share the same base fluid. The magnetic particles are attracted by the magnetic field of the MR clutch when active and therefore remains in close proximity of the magnet. When the field is inactive however, the magnetic particles can migrate anywhere in the fluid unless a permanent magnet is placed near the frictional interfaces. The second topology of FIG. 28B shows describes an impossible configuration where, from left to right, the key components are: MR-PUMP-TURBINE. In this configuration, the reactor is trapped and cannot be grounded either to the left or the right. PUMP cannot be in the middle of the component order. The third topology of FIG. 28C shows a preferred configuration where the torque converter and MR clutch share common parts while having separate cavities such that each device can use its own fluid without cross-contamination. From left to right, the key components are: MR-TURBINE-PUMP.

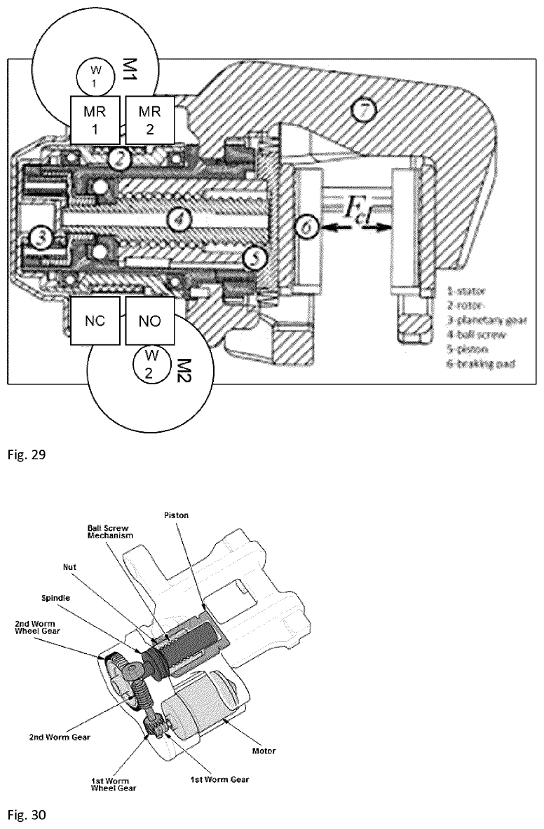

FIG. 29 shows a brake system in accordance with a variant of the present disclosure. The two rotary actuation sources M1 and M2 have different input speed ratios. A MR1 load path is of parking brake style and may provide a percentage (%) of max clamping force. The MR1 load path is slow acting on force application because of it may be a highly geared motor (e.g., 200:1), as shown in FIG. 30. However, it is fast acting on the force removal because of the lightly geared MR fluid clutch apparatus installed directly on the nut of the ball screw. The MR fluid clutch apparatus MR1 may be normally closed (NC): if current is removed, the MR fluid clutch apparatus MR1 may maintain its applied torque indefinitely. The MR fluid clutch apparatus MR1 may be controlled to be disengaged during braking so it may not influence the function of the MR2 load path. The MR1 load path may be composed of non-reversible gears so it may perform a parking brake function (at a percentage (%) of max force).

FIG. 30 shows a legacy highly geared electromechanical parking brake system.

MR2 chain may be of fast actuation style and can provide a percentage (%) of the clamping force. The MR2 chain may be fast acting on both force application and removal because it may have a lightly geared motor (e.g. 50:1). The fast acting of MR2 may allow fast displacement of the brake pad and full force (up to a percentage (%) of maximum force) to be applied in less than 10 ms. MR2 clutch may be normally open (NO) and controlled so it may not influence the function of MR2 during parking brake application. MR2 chain, with its high bandwidth (>50 Hz) may be able to regulate the clamping force (both positive or negative) in order to realise the functions that needs fast acting (Anti-looking brake (ABS), Electronic Stability Control (ESC), . . . ). When the force of MR2 alone may not be sufficient to provide the required force, MR1 force may be added to MR2 force to increase the clamping force. During normal function, MR1 may provide a base (DC type) braking force while MR2 may superimpose a highly controllable force (AC type).

Both MR1 and MR2 may be released with the same speed because they may be both connected to the same output mechanisms. MR clutches may be considered as inherent torque limiters that protect the system from any higher loading that could come from the braking system. Without MR clutches to protect the system, a larger ball screw may have to be selected, in combination with a larger lead, which may drastically increase the system weight. Due to the MR clutches, a much smaller ball screw may be used. This may allows a high lead angle and a high efficiency (>95%) ball screw to be used, thus ensuring that it may be backdriven when the maximum loads is reached and then may perfectly regulate the clamping force to be applied.

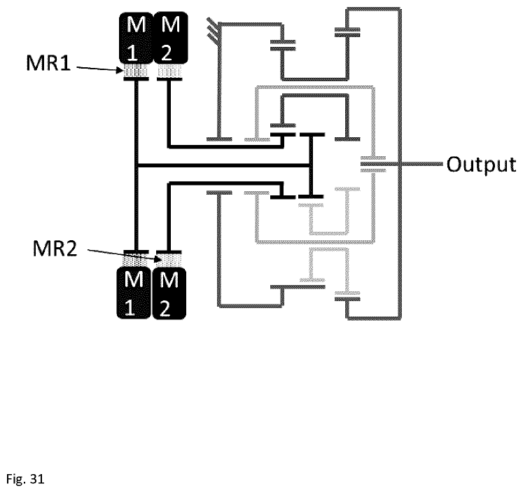

FIG. 31 depicts a system similar to the one of FIG. 16 but instead of using a spur gear system, it uses a wolfram gear system. All the systems from FIG. 11 to FIG. 32 may use various type of gear reduction mechanisms. The wolfram type of reduction mechanism may allow a reduction of the weight of the unit by allowing reduction stages of multiple MR actuators to share some components. On the architecture of FIG. 31, the two motors, M1 and M2, are located side by side on one side of the additive parallel load path actuator and the output is located on the other side.

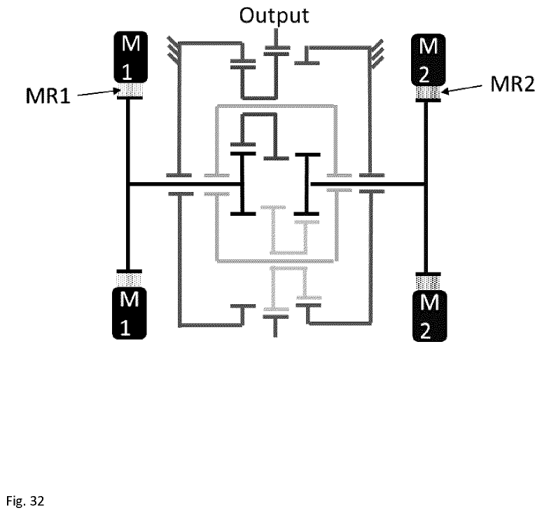

FIG. 32 shows an alternative configuration of the worlfram gear system where the two motors, M1 and M2, are on the opposite side of the additive parallel load path actuator and where the output is located in between. Many other variations of an additive parallel load path actuator using the wolfram gearbox may be implemented and as with the other concepts, one MR fluid clutch apparatus may be replaced by a torque converter. Additionally, multiple MR fluid clutch apparatuses may be replaced by multiple torque converters.

Accordingly, in the various embodiments of the additive parallel load path actuators described herein, to optimize the performance, the actuator inertia is decoupled from the system's output. Actuator inertia decoupling can be done by placing a specifically designed coupling between the power source and the system's output and allow the coupling to slip. The slippage condition allows the input and output to move at different relative speeds or directions without significantly affecting the force or torque transferred by the slippage interface. Wet or dry slippage systems can be used, but wet (fluidic) interfaces present major advantages of having better heat evacuation, better durability and/or smoother torque control characteristics.

A specific type of fluid couplings suitable at least in some of the variants of the additive parallel load path actuator described herein is embodied by magnetorheological (MR) fluid clutch apparatuses. Prior art revealed good overall performance of MR actuator systems that have (1) high dynamics (>30 Hz), (2) good torque density (5 to 100 N·m/Kg range depending on device size) and (3) low inertia (>10×less than direct drive motors of equivalent torque). MR fluid clutch apparatuses also offer relatively low friction and have good back driveability (˜1% of total force output of the system). The input of an MR fluid clutch apparatus may turn faster than the output. Thus, the MR fluid may slip inside the clutch in order to “prepare” the system for a rapid spike in torque requirement. The power dissipated through the fluid is the slippage speed multiplied by the torque of generated by the device. Thus, the higher the slippage rate, the higher the wear of the MR fluid. In a typical MR actuator, a significant trade-off exists between the slipping speed, performance and the durability of the MR fluid. MR fluid durability is limited to 1 MJ/ml and 10 MJ/ml.

Another type of fluid coupling suitable at least in some of the variants of the additive parallel load path actuator described herein is a torque converter. Prior art revealed good overall performance of torque converter actuator systems that have (1) torque multiplying capability (2) very good torque density (>100 N·m/Kg range depending on device size) and (3) low inertia (>10×less than direct drive motors of equivalent torque). The input of torque converter may turn slower than the output. Thus, the fluid may slip inside the clutch in order to ‘increase the torque capabilities of the system. The power dissipated through the fluid is the slippage speed multiplied by the torque of generated by the device. Thus, the higher the slippage rate, the higher the wear of the fluid. In a typical torque converter actuator, a significant trade-off exists between the slipping speed, performance, temperature and the durability of the fluid.

The controller 1 may be described as being part of a system for driving an output member of an additive parallel load path actuator. The system may include a processing unit and a non-transitory computer-readable memory communicatively coupled to the processing unit and comprising computer-readable program instructions executable by the processing unit for: controlling two or more fluidic couplings (e.g., MR fluid coupling 10, torque converter 102) having a common power source, to transmit torque in a common direction to a common output member. The controller 1 may therefore be used for: actuating the power source(s); controlling a first fluidic coupling and a second fluidic coupling to transmit torque from the single power source to the output member in: a first load path including solely the first fluidic coupling, a second load path including solely the first fluidic coupling, and a combination of the first load path and the second load path. When the first fluidic coupling is a torque converter, the computer-readable program instructions are executable by the processing unit for continuously increasing a torque from the first load path for instance by: increasing a speed of the power source to continuously increase the torque from the first load path; applying a braking force to an output of torque converter to continuously increase the torque from the first load path; controlling a stator of the torque convertor to continuously increase the torque from the first load path. The second fluidic coupling may be a magnetorheological fluid coupling, and the computer-readable program instructions are executable by the processing unit for controlling the magnetorheological fluid coupling to generate a variable amount of torque transmission via the second load path.

The additive parallel load path actuators described herein may be said to be actuator systems, as they include numerous components in addition to a power source, to enable the selective use of different load paths. The expression transmission may refer to the assembly of components interrelating the power source to the fluidic couplings, and the fluidic couplings to the output, in any of the embodiments described herein. The transmission may have different portions, i.e., sub-assemblies of transmission components.

1. An actuator system comprising:
a power source;
an output member;
at least a first fluidic coupling and a second fluidic coupling, the fluidic couplings operable to generate a variable amount of torque transmission;
a transmission operatively coupling the at least two fluidic couplings to the power source and to the output member in at least first load path and a second load path, the first load path and the second load path being parallel to one another,
the first load path including the first fluidic coupling,
the second load path including the second fluidic coupling,
wherein the fluidic couplings are operable for torque from the power source to be transmitted solely via the first load path, solely via the second load path, and cumulatively via the first load path and the second load path.

2. The actuator system according to claim 1, wherein at least one of the fluidic couplings is a magnetorheological (MR) fluid clutch apparatus, the MR fluid clutch apparatus operable to generate a variable amount of torque transmission when subjected to a magnetic field.

3. The actuator system according to claim 2, wherein the first fluidic coupling and the second fluidic coupling are MR fluid clutch apparatuses.

4. The actuator system according to claim 3, wherein the MR fluid clutch apparatus in only one of the MR fluid clutch apparatuses has a combination of a permanent magnet and an electromagnetic coil concurrently operable to vary the amount of torque transmission.

5. The actuator system according to any claim 1, wherein at least one of the fluidic couplings is a torque converter.

6. The actuator system according to claim 1, wherein one of the fluidic couplings is replaced by a mechanical one-way freewheel device.

7. The actuator system according to claim 1, wherein the transmission includes a first speed reduction mechanism in the first load path.

8. The actuator system according to claim 7, wherein the transmission includes a second speed reduction mechanism in the second load path.

9. The actuator system according to claim 8, wherein a reduction ratio of the first speed reduction mechanism differs from a reduction ratio of the second speed reduction mechanism.

10. The actuator system according to claim 1, wherein the transmission includes intermeshed gears.

11. The actuator system according to claim 1, wherein the transmission includes pulleys and belts.

12. The actuator system according to claim 1, including a controller for controlling the fluidic couplings to selectively drive the output member solely in the first load path, solely in the second load path and cumulatively in the first load path and the second load path.

13. The actuator system according to claim 1, wherein
the first fluidic coupling has a first input coupled to the power source, and a first output to selectively transmit torque as a function of a control of the first fluidic coupling;
the second fluidic coupling has a second input, and a second output to selectively transmit torque as a function of a control of the second fluidic coupling;
the transmission has a first portion between the input of the first fluidic coupling and the input of the second fluidic coupling;
the transmission has a second portion between the output of the first fluidic coupling and the output of the second fluidic coupling;
the first load path includes the first input to the first output of the first fluidic coupling;
the second load path includes the first input to the second input via the first portion of the transmission, the second input to the second output of the second fluidic coupling, and the second output to the first output via the second portion of the transmission.

14.-16. (canceled)

17. An actuator system comprising:
at least two load paths, each of the load paths including at least
a power source, and
a fluidic coupling controllable to generate a variable amount of torque transmission;
an output member common to the two at least two load paths;
a transmission operatively coupling the at least two MR actuator units to the output member, for the output member to receive torque from the at least two load paths;
wherein the fluidic couplings are controllable for torque from the power sources to be transmitted solely via the first load path, solely via the second load path, and cumulatively via the first load path and the second load path; and
wherein at least one of the fluidic couplings is a torque converter.

18. The actuator system according to claim 17, wherein the transmission includes a first speed reduction mechanism in the first load path.

19. The actuator system according to claim 18, wherein the transmission includes a second speed reduction mechanism in the second load path.

20. The actuator system according to claim 19, wherein a reduction ratio of the first speed reduction mechanism differs from a reduction ratio of the second speed reduction mechanism.

21. The actuator system according to claim 17, wherein the transmission includes intermeshed gears and/or pulleys and belts.

22. (canceled)

23. The actuator system according to claim 17, including a controller for controlling the fluidic couplings to selectively drive the output member solely in the first load path, solely in the second load path and cumulatively in the first load path and the second load path.

24. A system for driving an output member of an actuator system, the system comprising:
a processing unit;
a non-transitory computer-readable memory communicatively coupled to the processing unit and comprising computer-readable program instructions executable by the processing unit for:
actuating at least one power source;
controlling a first fluidic coupling and a second fluidic coupling to transmit torque from the single power source to the output member in:
a first load path including solely the first fluidic coupling,
a second load path including solely the first fluidic coupling, and
a combination of the first load path and the second load path.

25.-29. (canceled)
